(19) United States
(12) Patent Application Publication
(10) Pub. No.: US 2023/0312417 A1
(43) Pub. Date: Oct. 5, 2023

(54) DEGRADABLE MATERIALS CONTAINING WASTE PAPER PRODUCTS

(71) Applicant: PACT RENEWABLES PTY LTD, Thornleigh (AU)

(72) Inventors: Aharon ARAKEL, Thornleigh (AU); Bithi ROY, Thornleigh (AU); Rubick ARAKEL, Thornleigh (AU)

(73) Assignee: PACT RENEWABLES PTY LTD, Thornleigh (AU)

(21) Appl. No.: 18/011,717

(22) PCT Filed: Jun. 23, 2021
(86) PCT No.: PCT/AU2021/050650

§ 371 Date: Dec. 20, 2022

(30) Foreign Application Priority Data
Jun. 25, 2020 (AU) 2020902121

(51) Int. Cl. C04B 18/24; C04B 28/14; C04B 22/14; C04B 22/06; C04B 14/36; C05F 9/04; C05D 1/02; C05G 5/40; C05G 3/80; C05G 1/00

(52) U.S. Cl. CPC C04B 18/243; C04B 28/14; C04B 22/142; C04B 22/066; C04B 14/36; C05F 9/04; C05D 1/02; C05G 5/40; C05G 3/80; C05G 1/00; C04B 2103/0072

(57) ABSTRACT

Disclosed herein are feedstock materials which can be used for the manufacture of industrial products and consumer goods. The feedstock materials comprise particles of a comminuted paper product having fibrous portions on an outer surface thereof distributed throughout a diagenetically formed mineral aggregate comprising gypsum, syngenite and magnesium hydroxide and/or magnesium sulphate. The feedstock material, and products produced therefrom, is adapted to degrade when buried. Also disclosed herein are methods for producing the feedstock materials, and products produced from the feedstock materials.

### TECHNICAL FIELD

The present invention relates to degradable feedstock materials that incorporate comminuted paper products into a diagenetically formed mineral aggregate. The invention also relates to degradable products formed from such feedstock materials and to methods for producing the feedstock materials and products.

### BACKGROUND ART

Paper products such as paper and cardboard can be recycled multiple times, albeit with a decrease in quality during each subsequent recycling loop. Currently, however, all uses of waste paper and cardboard fail to avoid incineration and/or landfilling at the end of their life cycle, which causes adverse environmental and impacts and has an associated cost.

Furthermore, logistical difficulties associated with the transport and recycling of used paper and cardboard may result in them either not being recycled at all, or being discarded (i.e. via incineration and/or landfilling) before they reach the end of their life cycles. Indeed, waste paper and cardboard represent approximately 35% of the total production of solid waste globally.

Reducing incineration and landfilling of waste paper and cardboard would have numerous benefits, both from an economic and environmental perspective.

### SUMMARY OF THE INVENTION

In a first aspect, the present invention provides a feedstock material (e.g. for the manufacture of industrial products and consumer goods, such as those described below) comprising particles of a comminuted paper product (e.g. waste cardboard and/or waste paper) having fibrous portions on an outer surface thereof distributed throughout a diagenetically formed mineral aggregate comprising gypsum, syngenite and magnesium hydroxide and/or magnesium sulphate, wherein the feedstock material is adapted to degrade when buried.

In a second aspect, the present invention provides a granulated feedstock material comprising particles of a comminuted paper product (e.g. waste cardboard and/or waste paper) having fibrous portions on an outer surface thereof distributed throughout a diagenetically formed mineral aggregate comprising gypsum, syngenite and magnesium hydroxide and/or magnesium sulphate, wherein the feedstock material is adapted to degrade when buried. The granulated feedstock material may, for example, be provided in the form of a wet granule or a granule-containing sheet.

As will be described in further detail below, the present invention advantageously provides a feedstock material that can include a significant proportion of waste paper and/or cardboard and which can, in some applications, be used as is or, in other applications, used for the subsequent manufacture of useful products. Such products have a wide range of industrial and consumer applications and many would otherwise be produced from materials such as plastics.

The present invention can therefore provide dual advantages, namely a reduction in the amount of end of lifecycle waste paper and/or cardboard being disposed of, as well as a reduction in the amount of materials such as plastics that would otherwise be required to manufacture the products. Indeed, one of the primary applications for the present invention this is currently envisaged is in the agricultural industry where reliance on plastic (as well as other materials such as synthetic polymers, compressed paper, paperboard, organic fibres and metallic materials) products such as plantable containers for plants is causing an enormous environmental impact.

Further, the degradable feedstock materials of the present invention can be formed from readily available and sustainably sourced minerals and can be used to produce products having structural and functional properties which make them especially suitable for use in a wide range of applications, which products degrade when placed in soil upon reaching the end of their useful life. As the feedstock material (and hence products formed from the material) is adapted to degrade when buried, provision for an ultimate sustainable degradation is provided.

Furthermore, in many embodiments of the present invention, such degradation may provide soil conditioning effects.

In some embodiments, the comminuted paper product may have a size of about 0.2-1 cm across. In some embodiments, the feedstock material may comprise between about 10% and 60% (w/w) of the comminuted paper product.

In some embodiments, the feedstock material may comprise between about 30% and 80% (w/w) gypsum. In some embodiments, the feedstock material may comprise between about 0.5% and 30% (w/w) syngenite. In some embodiments, the feedstock material may comprise between about 2% and 10% (w/w) of magnesium hydroxide and/or magnesium sulphate.

In some embodiments, the magnesium hydroxide and/or magnesium sulphate may be selected from one or more of the group of naturally occurring minerals consisting of: brucite, kieserite, starkeyite, epsomite and struvite.

In some embodiments, the feedstock material may further comprise one or more additives selected from the group consisting of: inorganic fillers, organic fibers, pesticides, colourants, coating agents and fertilisers.

In a third aspect, the present invention provides a product produced from the feedstock material of the first or second aspect of the invention. The product may comprise or consist entirely of the feedstock material. Products envisaged by the inventors and described in further detail below include a plantable container, a mulch for weed control, a soil conditioner, a fertliser, a growth media, a media for control of malodour, a filler for goods packaging and padded envelopes, food waste containing compost amendment and decorative garden pebbles.

In a fourth aspect, the present invention provides a method for producing a feedstock material that is adapted to degrade when buried. The method comprises:
comminuting a paper product (e.g. waste paper and/or cardboard) whereby particles having a fibrous portions on an outer surface thereof are produced;
mixing the particles of comminuted paper product with a precursor mineral mixture that comprises finely ground bassanite, magnesia and arcanite; and
hydrating and stirring the mixture, whereby a self-binding mineral aggregate diagenetically forms, with the comminuted paper particles distributed throughout.

Advantageously, the precursor mineral mixture utilised for the production of degradable feedstock materials according to the method of the present invention includes widely available mineral materials, some of which can be sourced from non-depletable resources such as seawater. The comminution and solid-liquid mixing steps in the method are also not necessarily energy and water intensive, as is often the case for conventional feedstock materials production (e.g. those involving wet pulping for paper/cardboard repurposing). The inventors note that it is a significant advancement in the art that the feedstock materials and resulting products described herein can be mass manufactured without severe environmental disturbance.

In some embodiments, the paper product may be comminuted by dry defibring or chipping. In some embodiments, the paper product may be comminuted such that particles having a size of about 0.2-1 cm across are produced. In some embodiments, the proportion of comminuted paper product to the precursor mineral mixture may be from about 10% (w/w) and 60% (w/w).

In some embodiments, the method may further comprise screening the particles of comminuted paper product to remove any foreign material (e.g. metallic material such as staples, plastics such as labels, etc.).

In some embodiments, the method may further comprise adding a seeding agent during stirring of the mixture, whereby the setting time of the mineral aggregate is affected.

In some embodiments, the method may further comprise adding a retarding agent effective to slow the setting of the mineral aggregate is added during stirring of the mixture.

In some embodiments, the method may further comprise blowing a gas into the mixture during stirring, whereby the porosity of the mineral aggregate (and hence the produced feedstock material) is increased.

In some embodiments, the amount of water used to hydrate the mixture may be between about 10% (w/w) and 200% (w/w) relative to the weight of the total solids.

In some embodiments, the precursor mineral mixture may comprise between about 30% (w/w) and 97.5% (w/w) of bassanite (by weight of dry mixture). In some embodiments, the precursor mineral mixture may comprise between about 2% (w/w) and 50% (w/w) of magnesia (by weight of dry mixture). In some embodiments, the precursor mineral mixture may comprise between about 0.5% (w/w) and 20% (w/w) of arcanite (by weight of dry mixture). In some embodiments, the finely ground bassanite, magnesia and arcanite may have a particle size of between about 0.05 mm and 2 mm.

In some embodiments, one or more additives may be mixed with the particles of comminuted paper product and the precursor mineral mixture. Such additives may, for example, include inorganic fillers, organic fibers, pesticides, colourants, coating agents and fertilisers.

In some embodiments, the method may further comprise granulating the self-binding mineral aggregate with the comminuted paper particles distributed throughout, whereby a feedstock material in the form of a wet granule is produced. In some of such embodiments, the wet granule may be further processed to produce a sheet material comprising granules.

In some embodiments, the method may further comprise shaping the feedstock material into a shape that defines a product (e.g. by pouring into a shaping apparatus such as a mould). In some embodiments, the method may further comprise drying the feedstock material whereby a product is formed.

In a fifth aspect, the present invention provides a method for producing a product from a feedstock material. The method comprises:
producing a feedstock material by:
   comminuting a paper product whereby particles having fibrous portions on an outer surface thereof are produced;
   mixing the particles of comminuted paper product with a precursor mineral mixture that comprises finely ground bassanite, magnesia and arcanite; and
   hydrating and stirring the mixture, whereby a self-binding mineral aggregate diagenetically forms, with the comminuted paper particles distributed throughout, and
producing the product by:
   shaping the feedstock material into a shape that defines a product (e.g. by pouring into a shaping apparatus such as a mould); and
   drying the feedstock material (e.g. at room temperature) whereby the product is formed.

In a sixth aspect, the present invention provides a self-binding feedstock material in the form of a wet aggregate that is produced by hydrating and stirring a mixture comprised of (optionally screened) dry pulp and/or chippings and a precursor mineral mixture comprising finely ground bassanite, magnesia and arcanite and, optionally, one or more additives.

In a seventh aspect, the present invention provides a self-binding feedstock material in the form of a wet granule that is produced by hydrating and stirring a mixture comprised of (optionally screened) dry pulp and/or chippings and a precursor mineral mixture comprising finely ground bassanite, magnesia and arcanite and, optionally, one or more additives to form a wet aggregate, and then granulating the wet aggregate.

Also disclosed herein are feedstock materials, in the form of either wet aggregate, wet granule or wet sheet containing granules, which feedstock materials is comprised of defibred or chipped waste paper or cardboard, and minerals of gypsum, syngenite, as the major components, and one or more of magnesium hydroxide and sulphate, as the minor components, wherein the said aggregate, granule, or sheet is used for manufacture of industrial products and consumer goods, and adapted to degrade when placed in soil.

Also disclosed herein are products and goods produced from the feedstock materials, having wide ranging industrial and consumer applications. The feedstock materials may, for example, be shaped to define products, such as plantable containers, soil conditioners and goods packaging fillers.

Also disclosed herein are industrial products and consumer goods using feedstock materials that are free from plastics, polymers or metals, wherein the said products and goods degrade upon reaching their useful life and placement in soil. Additionally, the optional use of other solid and liquid waste steams originating from construction and demolition activities, and food supply chain (production, consumption and waste management processes) in the production of feedstock materials of the present invention provides significantly added environmental advantages. This integrated use of multiple waste streams with waste paper and cardboard, can provide benefits unmatched by methods currently used or proposed in previous art for addressing the challenge of waste paper and cardboard waste. Consequently, products and goods made from feedstock materials of the present invention provide enormous positive environmental and economic impacts.

Also disclosed herein are methods for producing degradable feedstock materials in the form of wet aggregate, wet granules or wet sheet containing granules for use in manufacturing industrial products and consumer goods, comprising the steps of:
(a) dry defibring or chipping of a pre-determined amount of waste paper and/or cardboard using an appropriate defibring or chipping apparatus to produce a dry pulp or chippings;
(b) screening the dry pulp or chippings from step (a) to separate metal/plastic and other residues using an appropriate screening apparatus;
(c) using an appropriate solid-liquid mixing vessel, mixing the screened dry pulp and/or chippings from step (b) with a pre-determined amount of precursor mineral mixture, and optionally one or more additives, while moisturising the mixture with a pre-determined amount of freshwater sprayed onto the mixture to produce a wet aggregate; and
(d) transferring a predetermined amount of the wet aggregate from step (c) to an appropriate granulating vessel to produce wet granules.

Also disclosed herein are methods for manufacturing industrial products and consumer goods, agricultural products, goods packaging materials, odour control media, decorative, nutritious garden products and compost amendments using the methods of the present invention.

The feedstock materials of the present invention may advantageously be used for manufacturing of the aforementioned and other industrial products and consumer goods, which products and goods can be mass manufactured using conventional equipment at a substantially lower life cycle cost than currently available for products and goods having similar structural features and functionality. Further, they become degraded over time after placement in soil through interaction of physical, chemical and biological processes, generating a residue having conditioning effects on the receiving soils, thus eliminating the need for landfilling or incineration.

Other aspects, features and advantages of the present invention will be described below.

### DETAILED DESCRIPTION OF THE INVENTION

The overarching aim of the present invention is to provide new and useful degradable feedstock materials that may incorporate a significant amount of waste paper products, such as end of life paper, cardboard or a combination thereof. The feedstock materials can subsequently be used in applications such as packaging or odour control or to manufacture industrial products and consumer goods having functionality and added environmental benefits comparable or better than the industrial products and consumer goods already available in markets. In some embodiments, for example, the products and goods formed from the feedstock materials of the present invention may have functional advantages, as well as being cheaper to produce, when compared with those products formed from conventional materials (especially plastics and polymeric materials). However, fundamental to the present invention is the premise of unique environmental advantages, particularly the substantial reduction or elimination of the need for landfilling or incineration of the said products and goods at the end of their useful life.

Furthermore, the inventors believe that additional to reduction or elimination of landfilling or incineration, embodiments of the present invention uniquely offer the opportunity to use cheap and plentiful waste resources, such as construction and demolition materials and food waste, for manufacturing products and goods to provide multiple environmental and cost reduction benefits that are unmatched by comparable products already available in the markets. Additionally, feedstock materials may also advantageously be produced that incorporate nutrients and pesticides for producing products that provide both soil conditioning effects and crop protection upon placement in soils or on a substrate.

The inventors note that because of their advantageous structural integrity (i.e. dimensional stability) and functionality (e.g. water retention capacity and nutrient-carrying capacity), the feedstock materials of the present invention may have wider applications than domestic and commercial agriculture, goods packaging, mine site rehabilitation, and food production and its waste management, and other industries further elaborated in the following embodiments.

As noted above, the present invention provides a feedstock material or a granulated feedstock material comprising particles of a comminuted paper product (e.g. waste cardboard and/or waste paper) having fibrous portions on an outer surface thereof distributed throughout a diagenetically formed mineral aggregate comprising gypsum, syngenite and magnesium hydroxide and/or sulphate, wherein the feedstock material is adapted to degrade when buried.

In specific embodiments, feedstock materials may be provided in the form of either wet aggregate, wet granule or wet sheet containing granules (described in further detail below) and comprised of defibred or chipped waste paper and/or cardboard and minerals of gypsum, syngenite as the major components, and magnesium hydroxide and/or sulphate as the minor components. The feedstock material may be used for the manufacture of industrial products and consumer goods.

By definition, in the context of the present invention, “degradable feedstock materials” or “feedstock materials” means materials in the form of wet aggregate, wet granular or wet sheet containing granules, that contain a significant amount of a comminuted paper product or products (such as pulp and/or chippings sourced from waste paper and/or cardboard) as part of its solids content.

A “paper product” is a material that comprises or is formed from paper, and includes paper and cardboard, preferably waste paper and cardboard and especially end of lifecycle waste paper and cardboard.

The term “binder” is used interchangeably with the term “mineral aggregate” in the present disclosure, and means a hydrated mineral mixture which can bind dry pulp and/or chippings to produce a feedstock material as defined above.

The term “diagenetic reactions” or “diagenesis” refers to post-depositional reactions taking place in a sediment until it is consolidated, including chemical reactions with pour water, cementation and compaction processes to produce diagenetically formed minerals.

The abundance of the minerals constituting a binder or a mineral aggregate, as determined qualitatively by X-Ray Diffraction method and referred to in this invention, are classified as major (>30%), moderate (10-30%) and minor (<10%) amounts.

The present invention also provides a method for producing a feedstock material that is adapted to degrade when buried. The method comprises:
comminuting a paper product (e.g. waste paper and/or cardboard) whereby particles having a fibrous portions on an outer surface thereof are produced;
mixing the particles of comminuted paper product with a precursor mineral mixture that comprises finely ground bassanite, magnesia and arcanite; and
hydrating and stirring the mixture, whereby a self-binding mineral aggregate diagenetically forms, and throughout which the comminuted paper particles are distributed.

In specific embodiments, the method may be used for producing degradable feedstock materials in the form of wet aggregate, wet granules or wet sheet containing granules for use in manufacturing industrial products and consumer goods. In such embodiments, the method may comprise the steps of:
(a) dry defibring or chipping of a pre-determined amount of waste paper and/or cardboard using an appropriate defibring or chipping apparatus to produce a dry pulp or chippings;
(b) screening the dry pulp or chippings from step (a) to separate metal/plastic and other residues using an appropriate screening apparatus;
(c) using an appropriate solid-liquid mixing vessel, mixing the screened dry pulp and/or chippings from step (b) with a pre-determined amount of precursor mineral mixture, and optionally one or more additives, while moisturising the mixture with a pre-determined amount of freshwater sprayed onto the mixture to produce a wet aggregate; and
(d) transferring a predetermined amount of the wet aggregate from step (c) to an appropriate granulating vessel to produce wet granules.

Depending on the quality of waste paper and/or cardboard and intended end uses of the feedstock materials, step (b) of the process may optionally be followed by heating the screened dry pulp or chippings to a pre-determined temperature in a pressurised vessel to eliminate microbial contaminants. The precursor mineral mixture is comprised of finely ground bassanite, magnesia and arcanite, which minerals can be advantageously obtained from non-depletable resources, such as reject brine from seawater desalination plants and inland salt lake brines. The process of moisturising the mixture by means of water spray in step (c) can be achieved using freshwater.

The feedstock materials of the present invention, detailed below, and products including or formed from the feedstock materials may be degraded through time when buried via a combination of physical, chemical and biological processes after placing in soil or upon a substrate (such as domestic gardens, commercial orchards, mine site tailing dams, land divisions earmarked for housing construction, poultry and pig farms, capped landfills or brownfields, rooftop gardens, etc.). Further, the feedstock materials or products including or formed from the feedstock materials can be directly disposed safely in a landfill or even in households/industrial garbage bins designated for food waste.

The feedstock materials of the present invention (and products including or formed from the feedstock materials) may be used for manufacturing products and goods according to steps disclosed in the following embodiments. Given their degradability, mouldability, self binding and fast setting functions, as well as having low bulk density, the feedstock materials of the present invention would be useful for any number of other applications compatible with their structural and functional features.

The products for which the degradable feedstock materials find particular application include, but are not limited to, domestic and large agricultural consumables (such as garden mulch, soil conditioners, grow media and plantable containers), fillers for goods packaging, decorative garden products, odour control in food production and waste management and compost amendments. Accordingly, the present invention provides a feedstock material suitable for use in the manufacturing of industrial products and consumer goods, wherein the feedstock material is substantially comprised of waste paper and/or cardboard and mineral aggregates.

In at least some embodiments, the present invention provides low density, shapable, self-binding, and fast setting functional feedstock materials. In some embodiments, the precursor minerals may be extracted from seawater, brines from desalination processes and inland salt lakes or from naturally occurring mineral deposits, making the feedstock materials' production even more environmentally friendly. Consequentially, the manufacturing operations of the products described herein are significantly more economic and environmentally sustainable, compared to industrial products and consumer goods of prior art. In the case of agricultural applications for example, compared to conventional degradable containers, the degradable plantable containers of the present invention may have improved form stability, strength and structural matrix and workability, all considered highly desirable for their mass production. As an example, the inventors have found that plantable containers produced in accordance with embodiments of the present invention have a high degree of functionality, including controllable water retention capacity for reduced water usage and nutrient runoff, as well as degradability that is affected by environmental conditions, for example, upon placement into soil or earth, particularly advantageous for planting in remotely located forests and or mine site tailing locations.

Feedstock Materials

The feedstock materials of the present invention include a significant amount of paper products such as pulp and/or chippings sourced from waste paper and/or cardboard, as well as gypsum and syngenite as the major mineral components, and magnesium hydroxide and/or sulphate as the minor/trace components. The feedstock materials' components are individually described below.

Paper Products

Paper/cardboard suitable for use in production of feedstock materials according to the present invention includes containerboard and its corrugated fibreboard varieties, folding boxboard, solid bleached and unbleached cardboards, white lined chipboard and binder's board as well as clean food packaging containers and any other paper and cardboard, all originating from wood fibres. The above definition encompasses any cardboard that can be recycled for industrial or domestic use, i.e. for composting or shredded animal bedding, as well as any cardboard having reached the end of its last recycling loop such as such as egg cartons and takeaway drink trays.

Defibred or chipped waste paper/cardboard is one of the degradable components of the feedstock materials of the present invention. A commercially available or a purpose-built defibring/chipping (trituration, comminution, defibring) apparatus, producing a reasonably homogenous pulp with fibrous outlines or chippings with a size range of 0.2-1 cm across, as the desired particle size range, is the preferred means. As disclosed in the following embodiments, the purpose-built apparatus can include provisions for production of dry pulp/chippings with specific aspects including fine fibres having a desired range of length to width ratios.

The amount of paper/cardboard in the feedstock materials of the present invention varies, depending on the functionality of feedstock materials for commercial applications such as compressive and flexural strength, durability and bulk density of the product or good produced. The amount of paper/cardboard, as a weight percentage (w/w) of aggregate, granular and sheet form feedstock materials, ranges between 10% and 60%. As an indication, the paper/cardboard content of feedstock used for producing goods packaging fillers, soil conditioners and garden granules and pebbles, compost amendments and odour control media between 30% and 60% and for plantable containers between 10% and 30%.

The role of dry pulp or chippings in the feedstock materials is multi-faceted and may, in specific embodiments, include:
having fibrous particle boundaries, they enmesh effectively with mineral aggregates and optionally additives to provide the resulting feedstock materials with a stronger binding effect and hence form stability of the products and goods;
flexibility of and flexural strength of the products and goods made from the feedstock materials containing fibrous pulp and chippings;
effective moisture absorption of fermented liquid by dry pulp or chippings plays a fundamental role in control of odour generated in food production and supply industries as well as high water retention capacity of products, such as agricultural containers, produced from feedstock materials of the present invention;
dry pulp and chippings, while providing structural integrity to products and goods, are naturally biodegradable, but once placed in soil become degraded along with the binder holding the particles of pulp and chippings;
dry pulp and chippings lower the pH of mineral aggregate which in turn offsets the high pH due to formation magnesium hydroxide mineral in the feedstock materials; this optimises the setting time of the feedstock materials and environmental conditions for plants requiring pH adjustment;
dry pulp and chippings are very effective colour absorbents for the purpose of colour coding of the goods and products;

Gypsum

Gypsum (also known as calcium sulphate dihydrate—CaSO₄·2H₂O) is a hydraulically settable mineral but a weak binder. However, the feedstock materials including gypsum, the paper product and the other binders of the present invention provide strong structural matrix and dimensional stability to products and goods manufactured thereof. The inventors have demonstrated, however, that upon contact with soil moisture and added water, the products and goods thus produced become mineralogically unstable and, partly also driven by volumetric expansion of the cardboard, give way to eventual disintegration through a combination of physical, chemical and biological processes, as described in further detail below.

In the present invention, gypsum formed from rehydration of the bassanite in the precursor mineral mixture, along with dry pulp/chippings form the bulking agent, while providing a strong link with diagenetically formed syngenite and brucite as the main binding agents within the structural matrix of the feedstock material (and hence the products and goods). The conversion of bassanite to gypsum in the presence of dry pulp/chippings enables form setting, curing and evaporative dehydration processes, enabling production of a stable feedstock materials over a relatively short span of time.

Furthermore, when degraded, gypsum is a source of sulphur, which is a key component of certain essential amino acids that are the building blocks for proteins, as well as a principal element for chlorophyll synthesis, all important for plant growth. Many soils are now deficient in sulphur, which can result in the leaves of plants grown in the soil yellowing and cupping, as well as in flowers being smaller and paler. Gypsum is also a source of calcium, which is an essential element that plays an important role in nutrient uptake. Without adequate calcium, nutrient uptake and root development of plants slows. Calcium is also essential for many plant functions including cell division, soil wall development, nitrate uptake and metabolism, enzyme activity and starch metabolism. The addition of gypsum to soil occurs without a change to pH of the receiving soil.

Gypsum is the major component of the mineral-based feedstock materials of the present invention. The amount of gypsum in the feedstock materials may, for example be between about 30 and about 80% (w/w). The amount of gypsum in these feedstock materials may, for example, be at or above 30%, at or above 35%, at or above 40%, at or above 45%, at or above 50%, at or above 55%, at or above 60%, at or above 65%, at or above 70%, at or above 75% or at or above 80% (w/w) of the total weight of dry precursor mineral mixture in the feedstock materials.

Syngenite

Syngenite (CaSO₄·K₂SO₄·H₂O) is a fast setting double-sulphate mineral that is formed diagenetically according to the reactions described below. Syngenite is the dominant binding agent for feedstock materials of the present invention, giving form stability to the feedstock materials regardless of the extent of hydration or curing that has taken place. Syngenite can precipitate within feedstock materials, having arcanite contents as low as 0.5% w/w equivalent of total weight of dry precursor mineral mixture (w/w). However, as the presence of less hydraulic binder will make the resultant feedstock materials more soluble in water, the amount of arcanite additive can be adjusted according to the teachings of this invention in order to provide the desired stability versus degradability design requirements of the feedstock materials and products formed therefrom (e.g. plantable agricultural containers, which require form stability, as against aggregate and granular soil conditioners, which require relatively higher degradability when placed in soil).

Syngenite is a low bulk density slow-release secondary potassium fertiliser which may be used to neutralise a soil sensitive to chlorinity/salinity, improve the soil's pulping characteristics and reduce runoff erosion.

Syngenite comprises a minor to moderate component of the feedstock materials of the present invention. The amount of syngenite in the feedstock materials may, for example be between about 0.5 and about 30% (w/w). In some embodiments, for example, the amount of syngenite in the feedstock materials may, for example be between about 0.5 and about 10% (w/w), between about 10 and about 20% (w/w), between about 15 and about 25% (w/w), between about 15 and about 30% (w/w) or between about 20 and about 30% (w/w) of the total feedstock materials. In some embodiments, syngenite in the feedstock materials may comprise about 5%, about 10%, about 15%, about 20%, about 25% or about 30% (w/w).

Magnesium Hydroxide and/or Magnesium Sulphates

Magnesium based minerals in the feedstock material of the present invention include minerals of magnesium hydroxide and one or more magnesium sulphates, as described below.

Brucite

Brucite (also known as magnesium hydroxide—Mg(OH)₂) is a secondary hydraulically settable binder in the feedstock materials of present invention where freshwater is used for hydration, according to reactions described below. In the present invention, like syngenite, brucite is diagenetically precipitated through the reaction of matrix materials with freshwater under agitating conditions using a high shear mixer.

Brucite has a low solubility in water and, in addition to its binding and form stability effects, it can provide a number of benefits to products, such as plantable agricultural containers and poultry bedding materials made from the feedstock materials of the present invention. For example, brucite adjusts the pH of the feedstock materials prior to form setting, which is beneficial when additives requiring an alkaline environment are present, and often desirable in mass manufacture of products such as plantable agricultural containers. It also is well known for moisture and odour absorption properties, which are advantageously utilised for production of poultry bedding materials, in the present invention.

Other benefits of brucite relevant to agricultural applications of the invention include a pH adjustment of the soil and water in contact with the container, providing favourable plant growth environment (particularly in the case of containers with high water retention capacity), and soil conditioning properties of the containers inserted in soil or disposed in landfill, particularly in the case of soils or landfill materials having high acidity.

Brucite is a minor component of the feedstock materials of the present invention. The amount of brucite in the feedstock materials may, for example be between about 2 and about 10% (w/w) of total weight of dry precursor mineral mixture. In some embodiments, for example, brucite in the feedstock materials may comprise about 2%, about 4%, about 6%, about 8% or about 10% (w/w) of total weight of dry precursor mineral mixture.

Hydrated Magnesium Sulphate Minerals

Hydrated magnesium sulphate minerals have the chemical formula MgSO₄·nH₂O, where n can be from 1 to 7. Magnesium sulphate may be obtained from natural sources, and is also produced increasingly from a variety of industrial processes. The magnesium sulphate mineral type in the feedstock materials depends on the state of hydration of the mineral following curing, but are commonly recorded by x-ray diffraction analysis in the form of starkeyite (MgSO₄·4H₂O), kieserite (MgSO₄·H₂O) and/or epsomite (MgSO₄·7H₂O) and representing a minor component of the feedstock materials of the present invention. They form diagenetically in the mineral agglomerates of the present invention according to the reactions shown below.

MgO+H₂O→Mg(OH)₂ (magnesium hydroxide) [1]

MgO+CaSO₄·½H₂O+nH₂O→MgSO₄·nH₂O+CaSO₄·2H₂O [2]

### [Summary Reaction for Hydration Using Freshwater]

CaSO₄·½H₂O+K₂SO₄+MgO+nH₂O→CaSO₄·2H₂O+CaSO₄·K₂SO₄·H₂O+Mg(OH)₂+MgSO₄·nH₂O [3]

The number (“n” value) of water molecules in the hydrated magnesium sulphate mineral formed according to above-listed reactions depends on the hydration status of the mineral magnesium sulphate upon drying of the product manufactured from feedstock materials of the present invention. The “n” value can range between 1 and 7 with starkeyite (n=4) and epsomite (n=7) identified as the most common mineral types of magnesium sulphate salt.

Being highly water soluble, the roles of magnesium sulphate in the feedstock materials of the present invention are twofold, namely (a) dissolution in soil environment, facilitating the disintegration of the feedstock materials/product over time, and (b) providing nutritious effects on the surrounding soils.

Hydrated magnesium sulphate minerals are also a minor component of the feedstock material of the present invention and the amount may be as described above in relation to brucite.

Struvite

Struvite, also known as Struvite-K, is a valuable low-release synthetic fertiliser of mineral potassium magnesium ammonium phosphate mineral having the chemical formula [KMg(PO₄)·6(H₂O)] with a crystalline structure of precipitate in the range of 300-600 m.

Struvite is advantageously resistant to heat transfer while remaining slightly elastic, making it suitable for manufacture of agricultural containers, soil conditioners, compost amendments etc., produced according to the teachings of this invention. In the present invention struvite is a minor component of the feedstock materials, formed when either of monoammonium phosphate (MAP), diammonium phosphate (DAP) or certain food waste materials are added to precursor minerals during preparation of mineral aggregate in the presence of dried paper/cardboard pulp and chippings.

If present, the amount of struvite in the feedstock materials may, for example be up to about 5% (w/w), e.g. between about 0.1 and about 5% (w/w) of the binder in the feedstock materials. The presence and amount of struvite in the compost amendment using feedstock of the present invention directly reflects the type and amount of nitrogen pre-existing in the food waste materials used and/or the amount MAP or DAP added to the precursor mineral mixture as a nutrient supplement.

Precursor Mineral Mixture

The precursor mineral mixture, comprised of a pre-determined amount of finely ground bassanite (also known as calcium sulphate hemihydrate—CaSO₄·½H₂O), magnesia (MgO) and arcanite (K₂SO₄) is mixed with a pre-determined amount of comminuted paper products (e.g. dry pulped and/or chippings or a combination of the two) and hydrated to produce a wet feedstock material, which may subsequently be used in the manufacture of industrial products and consumer goods.

As will be described in further detail below, when the precursor mineral mixture is mixed with water in the presence of pulped and/or chipped waste paper or cardboard or a combination of the two, a self-binding wet aggregate is formed, with the bulk of resultant mineral particles having no orientation or alignment with respect to pulp or chipped particles, nor the direction of the flow of materials during the shaping (such as granulation or moulding) process. As disclosed below, the setting of the minerals in the feedstock materials may be adjusted to produce a wet aggregate or a wet granule with certain moisture content for specific applications, such as customised granular products with specific shapes, surface textural and colour effects, hardness and elasticity using conventional apparatus operated by a skilled person in the art.

Bassanite Bassanite (also known as calcium sulphate hemihydrate—CaSO₄·½H₂O) is the main constituent of the precursor mineral mixture. Bassanite is prepared either by calcination of gypsum mineral using conventional calcination or flash calcination processes. Gypsum may be obtained from a number of sources including naturally occurring gypsum deposits, and a number of synthetic gypsum varieties including phosphogypsum byproduct from phosphoric acid production processes, gypsum produced by calcination of recycled gyprock, gypsum recovered from seawater brines and bitterns and gypsum byproduct from flue gas desulfurisation processes.

A commercially available combined calciner-grinder apparatus is the preferred means for producing a homogenous and finely ground bassanite feedstock materials.

The majority of conventional technical approaches for using bassanite to manufacture gypsum-based products are based on direct conversion of traditional bassanite produced in conventional calcination processes to gypsum via a single-stage hydration process. However, it has now been demonstrated that, when reacted with water at low temperatures, bassanite mineral, regardless of its method of production, does not transform directly to gypsum mineral by a single-stage hydration process. In fact, it has been found that gypsum mineral forms in the second stage of the hydration of the bassanite mineral.

Accordingly, the finely ground bassanite, being a relatively soluble mineral, when reacted with water at room temperatures, produces a supersaturated solution in which, depending on the presence and ionic strength of other dissolved elements, calcium and sulphate ions can remain in solution for tens of minutes prior to the rearrangement of the bassanite sub-micron rods along the c-axis to form gypsum microcrystals. During this residence time, various reactions can take place and consequentially different mineral agglomerates can be formed. It has further been demonstrated that the residence time of the dissolved ions of calcium and sulphate, obtained from the mixing of finely ground bassanite with water at room temperature, can be further extended by addition of weak acids and their derivatives as retarding agents. These properties of staged hydration of bassanite are advantageously used in the present invention to produce mouldable self-binding feedstock materials, further described below.

The amount of bassanite in the precursor mineral mixture may be any amount effective to produce the mineral-based feedstock materials described herein. The bassanite may, in some embodiments, be between about 30% (w/w) and 97.5% (w/w) of the precursor mineral mixture. The bassanite may, in some embodiments, be 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% or 97.5% (w/w) of the precursor mineral mixture, relative to dry weight of mineral mixture or other incremental percentage between.

Magnesia

Magnesia (MgO) is highly reactive with water and is widely used as a flux in mineral processing absorbent in water, wastewater and odour control processes. Magnesia can advantageously be sourced from replenishable seawater by decomposing Mg(OH)₂ recovered from seawater brines and bitterns. Magnesia may also be produced from calcination of naturally occurring magnesite and dolomite ores as well magnesium rich by-products of processing of carbonate minerals in many parts of the world.

The amount of magnesia in the precursor mixture may be any amount effective to produce the feedstock materials described herein. The magnesia may, in some embodiments, be between about 2% (w/w) and 50% (w/w) of the precursor mineral mixture. The magnesia may, in some embodiments, be 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% (w/w) of the precursor mineral mixture, relative to dry weight of mineral mixture or other incremental percentage between.

Arcanite

Arcanite (also known as sulphate of potash, SOP—K₂SO₄) is a premium-quality potash fertilizer salt currently largely produced in a method commonly known as the Manheim Process, which involves the reaction of potassium chloride (KCl) salt (as the source of potassium ion) with sulphuric acid (as the source of sulphate ion). A significantly lesser tonnage of SOP is produced by mineral conversion (commonly known as secondary processes) which involves the reaction of KCl salt with naturally occurring minerals of sodium sulphate or magnesium sulphate (both minerals as sulphate ion donors).

Arcanite is used for cultivating high-value crops like fruits, vegetables, nuts, tea, coffee and tobacco, which are sensitive to chloride content in soil. The use of SOP improves quality and crop yields and makes plants more resilient to drought, frost, insects and even disease, as well as improving the look and taste of foods. It also improves a plant's ability to absorb essential nutrients like phosphorus and iron.

The amount of arcanite in the precursor mineral mixture may be any amount effective to produce the feedstock materials described herein excluding arcanite incorporated in N-P-K pellets added optionally as a nutrition source. The amount of arcanite in the precursor mineral mixture may be any amount effective to produce the mineral-based feedstock materials described herein. The arcanite may, in some embodiments, be between about 0.5% (w/w) and 20% (w/w) of the precursor mineral mixture. The arcanite may, in some embodiments, be 0.5%, 1%, 2%, 3%, 4%, 5%, 6%, 7%, 8%, 9%, 10%, 11%, 12%, 13%, 14%, 15%, 16%, 17%, 18%, 19% or 20% (w/w) of the precursor mineral mixture, relative to dry weight of mineral mixture or other incremental percentage between.

The precursor mineral mixture includes finely ground bassanite, magnesia and arcanite. In some embodiments, the finely ground bassanite, magnesia and arcanite may each have a particle size of between about 0.05 mm and 2 mm. In some embodiments, the bassanite, magnesia and arcanite may have the same particle sizes. In some embodiments, the bassanite, magnesia and arcanite may have different particle sizes.

A commercially available combined calciner-grinder apparatus is the preferred means for producing homogenous, finely ground feedstock materials. A finely ground particle can: (a) increase particle packing density and reaction rate by increasing the surface areas of the particles for the production of self-binding, fast setting and mouldable feedstock materials via direct chemical reactions and diagenetic processes which can include ion release and exchange, mineral dissolution/precipitation, incipient crystallisation and mineral phase change, (b) increase the textural homogeneity (distribution of porosity and permeability) of the structural matrix, (c) control the amount of water used for preparing mouldable and workable feedstock materials, and (d) optimise the microstructural engineering design criteria for mass production of products and goods such as plantable agricultural containers and sheet varieties of granular soil conditioners, having set water retention capacities.

Further (Optional) Additives

The present invention may optionally involve the use of additives in addition to pulp and/or chippings of paper/cardboard and precursor mineral mixture, where such additives do not deleteriously affect the formation and functionality of the feedstock materials and the products made therefrom. Examples of such additives, the inclusion of which may provide advantageous structural/functional properties or cost efficiencies to the feedstock materials and products made therefrom, will be described below.

Ammonium Phosphate

In some embodiments, monoammonium phosphate (MAP) or diammonium phosphate (DAP) may be optionally added directly to the precursor mineral mixture. MAP or DAP is a non-toxic highly water-soluble substance, having a chemical formula of NH₆PO₄ and is used as a source of P and N nutrients in many agricultural fertilisers. Addition of MAP or DAP at pre-determined amounts to the precursor mixture can result in production of wet feedstock materials in manufacturing of degradable industrial products and consumer goods pre-determined nutritive effects on the recipient soils. Rapid mixing of a pre-determined amount of MAP or DAP to the precursor mixture results in the formation of mineral struvite (NH₄MgPO₄·6H₂O) as a trace mineral component of the feedstock materials of the present invention.

The amount of MAP or DAP added to precursor mineral mixture is dependent on the mass ratio of arcanite to total weight of mineral mixture and can range from 0.1% to 5% relative to total weight of mineral mixture (w/w) and preferably from 0.5% to 3%, relative to total weight of mineral mixture (w/w). The amount added is adjusted during feedstock production to ensure the desired N-P-K ratio is retained in the feedstock material used as a source of nutrient release to receiving soils.

In some embodiments, the precursor mineral mixture may further comprise discrete fertiliser pellets distributed throughout, whereby the resultant feedstock materials further comprises the discrete fertiliser pellets distributed throughout products and goods produced therefrom. The feedstock materials may, for example, be prepared including nutritive pellets (hereafter named as “N-P-K pellets”) comprised of a predetermined mixture of MAP or DAP and arcanite. The N-P-K pellets may, for example, be cylindrical, spherical or other shape. The size of spherical or substantially spherical pellets can range from about 0.2 mm to 20 mm across.

Production of the N-P-K pellets may be performed, for example, by using a conventional pelletiser apparatus such as a rotating bottle or a tumbler. Microscopic examination reveals that such N-P-K pellets are comprised of a nucleus containing unreacted MAP or DAP and arcanite minerals surrounded by a rim including acicular crystals of syngenite that are perpendicularly oriented with respect to the surface of each pellet. The curing time of the N-P-K pellets is within the range of 5 minutes to 10 minutes, depending on the mass ratio of the mineral mixture to total amount of MAP or DAP and arcanite and to a lesser extent the volume of materials in the tumbler, mixing speed, and humidity of materials in the tumbler.

In some embodiments, the feedstock materials with N-P-K pellets produced according to the above method are particularly suitable for manufacture of degradable plantable containers aimed at soils having deficiencies in N-P-K nutrients, as well as mulch sheet or soil conditioners used for domestic or commercial applications, minesite tailings rehabilitation and revegetation of decommissioned landfills and brownfields. The pellets also assist the degradation process of the above mentioned products and goods because of faster dissolution of the pellets compared to the matrix materials because of enhanced development of secondary permeability zones.

Recycled Construction, Renovation and Demolition Waste

In some embodiments, for the purpose of value adding to the present invention, recycled materials from construction, renovation and demolition (CRD) activities, such as recycled gypsum plasterboard or even concrete particles may be advantageously used in conjunction with the binder and paper/cardboard pulp/chippings of the present invention, as a nucleus (core material) for production of decorative garden pebbles. A wet granulation apparatus can be used to mix the fragments of recycled CRD materials with dry pulp or chippings, water, precursor minerals, and optionally, additives in pre-determined proportions by weight (w/w). The granulation apparatus containing the above mixture is continuously operated until the fragmented CRD materials are encapsulated by the feedstock materials of the present invention. The mixing process may be continued and extra dry pulp and/or chippings and mineral aggregate may be added to achieve the desired thickness, shape, size and textural features for the decorative garden pebbles. The size of individual CRD fragments may vary, but typically range in between to 2 cm and 10 cm along the long axis and 3 cm and 5 cm along the short axis. A wide range of additives disclosed in this invention may be applied to provide certain effects and functionalities including but not limited to colour combinations, surface textural features such as smoothness, glossiness, as well as nutritious effects on the receiving soils.

Portland Cement

Portland cement is the basic ingredient of concrete, mortar, stucco, and non-specialty grout. Portland cement is a low-cost caustic cementing agent therefore widely used around the world. It is a hydraulic cement produced by pulverizing clinkers which consist essentially of hydraulic calcium silicates and predetermined amount of bassanite, with the latter used to absorb moisture and thus accelerate rate of expansion and hardening of cement. As the precursor mineral mixture of the present invention includes bassanite, it can opportunistically be used as a cementing agent for hardened cement fragments to produce cheap feedstock materials for large volume application areas such as decorative products including garden pebbles and granules.

In the present invention, considering its caustic nature, pre-determined amounts of Portland cement, water and pulp/chippings may be mixed in a granulation apparatus to form granules for garden decorative applications. The amount of Portland cement used can be up to 50% (w/w) of the total weight of the mixture introduced into the mixer, however, for producing decorative garden granules, the amount of Portland cement can be adjusted to values significantly lower by addition of powdered gypsum to offset the caustic effect of the Portland cement during reaction. Mixing of pulp/chippings, Portland cement and water in an orbital mixing process are found to be effective in forming dimensionally stable garden granules.

Starch

Starch is a low cost and widely available water dispersible natural polymer of glucose which is widely used in the design of novel superabsorbent hydrogels because of its hydrophilic nature (i.e., water retention properties and degradability for retention of nutrients and their release to soil). In the present invention, raw corn starch can be used as a low-cost supplementary binder to that of mineral aggregates for producing pulp-containing feedstock materials. Such feedstock, having improved smoothness, whiteness and gloss, is particularly suitable for improving printing characteristics of products and goods manufactured according to the teachings of the present invention. In such instances, the amount of starch added to the mineral mixture, pulp and water and mixed in a granulation apparatus to produce granules. The amount of starch added to the granulation apparatus may vary between 20%-50% (w/w), with preferred range being 35%-45% (w/w), while the mixing water temperature is maintained at around, or below 20° C.

Inorganic Fillers

In some embodiments, the precursor mineral mixture may also include one or more inorganic fillers, whereby the resultant feedstock materials further comprise the inorganic filler(s). Inorganic fillers may include any mineral type, ranging from gravel to clay particle size which are also generally inexpensive and can be procured easily in dry form, in any amount from many suppliers. Preference is given to fillers having minimum or no adherence to the shaping apparatus and thus minimising the need for releasing agents.

Contemplated inorganic fillers include quartzose sand, gravel, perlite, vermiculite, pumice, zeolites and fly ash from incineration process including but not limited to coal processing, waste-to-energy production and mineral processing operations. Addition of inorganic fillers enables the rheological behaviour, workability and reinforcement of the mixture and setting product to be controlled, improved, or otherwise adjusted. The use of inorganic fillers can therefore enable the micro-engineering design of products and goods exemplified in the present invention in terms of physical strength, product weight, density, brittleness, printability, water retention capacity, nutrient runoff in the case of the planted containers as well as final appearance, costing and degradability features of the products and goods.

Quartzose sand and its varieties include silica sand, glass, crushed quartz stone, amorphous silica, chalcedony, jasper, chert, flint and their coloured varieties are suitable fillers for use in the present invention for the purposes of increasing density and strength, with the finer particle size varieties preferred for also improving the workability of the feedstock materials for mass manufacturing in specific application such as granular soil conditioners for minesite tailings rehabilitation wherein resistance to wind and wind erosion are prime concerns.

The amount of quartzose sand added to mineral mixture can vary from 1% to 10% relative to total weight of mineral mixture (w/w), and preferably in the range of 3% and 7% (w/w) dry weight.

Gravel of any mineralogical aggregates provided it is washed first can be used with the amount corresponding to that of quartzose sand and crushed to coarse sand size preferred.

Because of inertness and inherent physical features (e.g. low mass, large air holding capacity and ease of handling), perlite may advantageously be used to adjust the weight and water retention capacity of the feedstock materials of the present invention. Perlite aggregates of various particle sizes can be directly added to the precursor mineral mixtures before adding water and transfer of the wet feedstock materials to an appropriate shaping and drying apparatus. Alternatively, prior to transfer to shaping/drying apparatus, the wet feedstock materials containing a predetermined amount of a particular sized perlite can be further treated by the methods of aeration, agglomeration and seeding, according to the following embodiments of this invention, with the objective of optimising the density of the structural matrix while increasing the water retention capacity as well as adjusting the density of products and goods.

Vermiculite has similar properties and applications to perlite but, in general, holds less air and more water and is less buoyant, making it a particularly suitable co-filler with fine particle size perlite for the manufacture of products and goods particularly in the form of hydroponic containers requiring controlled water-retention capacity.

Where the weight of containers of present invention is less relevant, zeolite may be used as an alternative inorganic filler for providing additional properties to the containers, notably improved water and nutrient absorption capacities.

In some embodiments the feedstock materials may be prepared from precursor mixtures that include one or more inorganic fillers. Individually, the amount of each inorganic filler can vary from 1% to 10% relative to total weight of mineral mixture (w/w), and preferably in the range of 3% and 7% dry weight. Depending on container applications, the total amount of perlite, vermiculate and pumice added individually or collectively to the mineral mixture can vary from 3% to as much as 50% relative to total weight of mineral mixture (w/w), and preferably in the range of 5% and 10% dry weight for compositions produced for containers earmarked for non-hydroponic applications.

Organic Fillers

In some embodiments, the precursor mineral mixture may also include one or more organic fibres to provide reinforcement, weight reduction, as well as a seeding agent for enhanced granulation and granularity of the feedstock materials (and products formed therefrom), whilst increasing the water retention capacity and adjusting the degradability features upon return to earth. The nature and amount of organic fibre can also affect the rheology and workability of the shapeable feedstock materials, for example, in manufacturing agricultural and ornamental containers for reduction of evaporative loss of ponded water. The incorporation of organic fibres in the wet feedstock materials also positively impacts on the manufacturing costs as well as the degradability of such products and goods.

Based on the foregoing, the optimum amount of organic fibres to be added or seeded to the mineral mixtures of the present invention shall be determined after trials conducted by a person skilled in the field in order to accommodate variation in the type of fibre species with particular attention given to their specific gravity.

The organic fibres can be selected from biodegradable fibres such as those available in the form of saw cuttings, wood shavings, straw, hay, coir, as well as hard woods, softwoods including naturally occurring organic fibres extracted from hemp, flax, sisal, jute, kenaf, cotton, plant leaves or stems such as pineapple leaves, any vegetal natural feedstock materials consisting of cellulose fibrils bounded in a matrix of hemicelluloses and lignin, etc. Typically, the fibres would have an aspect ratio of about 50:1 to about 5:1 and more preferably about 10:1, with the individual fibres having lengths less than about 5 mm and preferably less than 3 mm.

The organic fibers may be added or seeded to the mineral mixtures in amounts suitable for achieving a suitable degradability function of the resultant feedstock materials, as well as to enhance its water retention capacity. Generally, the fibers can be added in amounts of between about 3% and 10% relative to total weight of mineral mixture (w/w), more preferably less than about 5% by dry weight.

The organic additives include waste generated across the food supply chain, including food production, consumption and food waste management. Waste attributed to food industry include agri-food waste (cuttings from fruit and vegetable during production and packaging), food organics and garden organics from households and larger food consuming industries (restaurants, cafes, grocery retailers, hotels, schools, hospitals, military bases, aviation, cruise ships, cargo shipping, etc.) and waste from food waste compost production operations. The amount and particle size of food waste additive varies depending on the desired specifications. Typically, food particles would have an aspect ratio ranging between 5:1 and 10:1 with individual particles less than about 50 mm and preferably less than 20 mm. The amount of food particles used as a nucleus for making individual granulated compost amendment typically represents between 5% and 20% (w/w of total solid weight). It is suggested for the compost amendments to maintain the carbon-to-nitrogen ratio (C:N ratio) somewhere around 25-30:1. Approximate C-N ratio of the granular compost amendments produced from food waste is within the recommended range.

Pesticides

In some embodiments, a pesticide may be added to the precursor mineral mixture or granular or sheeted feedstock materials. Suitable pesticides may include insecticides, herbicide, bactericides, fungicides, rodenticides and larvicides. The function of the pesticide is to protect a terrain from pests such as weeds, insects and microorganisms. The pesticide(s) may be provided in the form of powder, agglomerates/pellets, capsules, etc. The selection of pesticides will depend on pesticide efficacy as determined by comparing benefits against the optimum amount of pesticide used to minimise potential environmental risks.

Generally, pesticides consist of several substances, including one or more active ingredients mixed with other accompanying compounds to stabilize the active agents and to enhance its controlled release or provide a synergistic effect between two insecticides or with an insecticide and a fertiliser regime. Accordingly, the pesticides in the products of the present invention will vary from one application to another.

Hormones or growth promotants made in the form of powder, agglomerates/pellets and capsules may also be included in the mineral mixtures of the present invention.

In one embodiment, for example, a predetermined amount of finely ground pesticide may be added to the precursor mixture and thoroughly mixed prior to further treatment according to the present invention. As some pesticides are poorly water soluble, to increase solubility it can be micronised, optionally to nano-particle size, prior to mixing with above mentioned mineral mixtures.

In another embodiment, a predetermined amount of finely ground pesticide may be added to a dry mix of the finely ground mineral mixture, and thoroughly mixed in an appropriate mixing vessel prior to granulation according to the steps described herein. Optionally, in the case of pesticide containing mulch sheets, the micronised pesticide ingredient can be directly mixed thoroughly in the matrix of the mulch containing N-P-K nutrients in discrete pellet form as described previously. Such pesticide containing mulch products empowered with N-P-K pellets (as point source controlled nutrient release) are highly desirable in remotely located large-scale plantations including but not limited to forestry, landscaping and mine site tailings vegetation operations.

Colourants/Coating Agents

In some embodiments, the wet feedstock materials may further comprise a colourant. Such substances may be used to provide colouration, surface sealing, water proofing, smoothening, glossiness and other desirable structural and surface textural effects including but not limited to visual appearance to final products and goods.

Any suitable colourant may be used. The colourant may, for example, be selected from degradable mineral oxides (e.g. iron, aluminium and silicon oxides), distress oxides, mica powder, indigo, food colourants, tea colourants, latex, metallic copper, chalk blue, henna, etc.

The colourant(s) may be applied during or after solid-liquid mixing step of the method for producing feedstock materials disclosed in the following embodiment. In some embodiments the wet feedstock materials may be prepared from a precursor mineral mixture that already includes one or more colouring agents/colourants. Generally, one or more finely ground colouring agents can be added directly to dry mineral mixture (which may include other additives) and subjected to high shear mixing before transfer to a solid-liquid mixing vessel for production of a wet aggregate. The colouring agents can be also applied in a solution form after shaping and curing the wet feedstock materials and even applied to the final product if it is desired to make the surface of the said product (or a part thereof) more waterproof or to give it a desirable surface texture (e.g. glossiness) for the purposes of printing, engraving or embossing. Where the objective is to apply a colourant solution, a solution of finely powdered colouring agent can be prepared by dissolving it in cold water at room temperature, and adjusting the balance of water to be added to the dry mineral mixture and mixed thoroughly under high shear mixing conditions to be coloured wet aggregate feedstock materials.

In some embodiments, a coating agent may be applied to products formed from the feedstock materials of the present invention to provide a desirable surface textural effect, such as colouration, sealing, smoothening, glossiness, improved dimensional stability, or a combination thereof. In such cases, the coating agents can be selected from degradable resins and rosins including but not limited to shellac, camphor, colophony rosin, gum copal, starch based adhesives, etc.

Generally, the coating agents are particularly appropriate for most varieties of containers, packaging beads, sculptures and floating objects produced from feedstock materials of present invention and applied after adequate curing so as to also improve the functionality and strength of the said products. However, as further elaborated in the following embodiments, aforementioned coating agents can also provide additional functions such as increasing water retention capacity to plantable containers, while also giving colouring and desired designer patterns to ornamental containers, for example. One skilled in the art will be able to determine the type and amount of colourant or coating agent to be added to the precursor mineral mixture or applied directly to shaped and cured products and goods from assessing the surface porosity, adequacy for desired colouring or coating effects and compatibility of the agents with respect to labelling/engraving requirements of the final product.

Optionally, the surface of the product/goods can be first thinly coated or sprayed with a 5-10% concentrate of starch solution in order to seal the surface pores of the dried objects prior to application of the colouring agent (in either solution or pigment form). The application rate of the colourant will therefore vary but, generally speaking, a finely powdered colourant having a concentration of less than about 0.5% relative to total weight of mineral mixture (w/w) and more preferably less than about 0.2% by dry weight would be suitable.

Method for Producing Feedstock Materials

The present invention provides a method for producing a feedstock material that is adapted to degrade when buried. The method comprises:
comminuting a paper product (e.g. waste paper and/or cardboard) whereby particles having a fibrous portions on an outer surface thereof are produced;
mixing the particles of comminuted paper product with a precursor mineral mixture that comprises finely ground bassanite, magnesia and arcanite; and
hydrating and stirring the mixture, whereby a self-binding mineral aggregate diagenetically forms, with the comminuted paper particles distributed throughout.

In one embodiment, the present invention provides a method for producing degradable feedstock materials in the form of wet aggregate, wet granules or wet sheet containing granules for use in manufacturing industrial products and consumer goods, comprising the following steps:
(a) dry defibring or chipping of a pre-determined amount of waste paper and/or cardboard using an appropriate defibring or chipping apparatus to produce a dry pulp or chippings;
(b) screening the dry pulp or chippings from step (a) to separate metal/plastic and other residues using an appropriate screening apparatus;
(c) using an appropriate solid-liquid mixing vessel, mixing the screened dry pulp and/or chippings from step (b) with a pre-determined amount of precursor mineral mixture, and optionally one or more additives, while moisturising the mixture with a pre-determined amount of freshwater sprayed onto the mixture to produce a wet aggregate; and
(d) transferring a predetermined amount of the wet aggregate from step (c) to an appropriate granulating vessel to produce wet granules.

Alternatively, in another embodiment, a self-binding feedstock materials can be produced by mixing and hydrating two dry components, comprised of a pre-determined amount of a dry mixture of bassanite and magnesia, as the first component, and a pre-determined amount of a dry mixture produced by hydrating a set amount of micronised arcanite and pulp/chippings, followed by drying, as the second component. The binding efficiency between the two parts of this alternative method, compared to method described in the embodiment above, relates to effectiveness impregnation of pulp/chippings with relatively low pH of 6-7 with micronized arcanite.

Method for Producing a Product from a Feedstock Material

The present invention also provides a method for producing a product from a feedstock material. The method comprises:
producing a feedstock material by:
   comminuting a paper product whereby particles having fibrous portions on an outer surface thereof are produced;
   mixing the particles of comminuted paper product with a precursor mineral mixture that comprises finely ground bassanite, magnesia and arcanite; and
   hydrating and stirring the mixture, whereby a self-binding mineral aggregate diagenetically forms, with the comminuted paper particles distributed throughout, and
producing the product by:
   shaping the feedstock material into a shape that defines a product (e.g. by pouring into a shaping apparatus such as a mould); and
   drying the feedstock material (e.g. at room temperature) whereby the product is formed.

In one embodiment, the present invention provides a method for producing degradable industrial products and consumer goods from feedstock materials of the present invention, comprising the following steps, with reference to earlier embodiments:
(a) defibring, chipping, or a combination thereof, of a pre-determined amount of dry waste paper and/or cardboard using an appropriate defibring or chipping apparatus to produce dry pulp or chippings;
(b) using an appropriate screening apparatus, screening the dry pulp or chippings from step (a) to separate residues (metal, plastic, etc) and produce screened dry pulp or chippings;
(c) using an appropriate solid-liquid mixing vessel, mixing the screened dry pulp and/or chippings from step (b) with a pre-determined amount of precursor mineral mixture, and optionally one or more additives, in room temperature, while moisturising the mixture with a pre-determined amount of water to produce a wet aggregate; optionally, adding milled oversized granules from step (h) and undersized granules from step (i) to solid-liquid mixing vessel in step (c);
(d) drying a pre-determined amount of wet aggregate from step (c) in an appropriate drying vessel to produce aggregate products;
(e) granulating a pre-determined amount of wet aggregate from step (c) in an appropriate granulating vessel to produce wet granules;
(f) Drying the wet granules from step (e) in an appropriate drying vessel to produce granular products;
(g) Drying a pre-determined amount of wet granules from step (e) in an appropriate drying vessel to produce dry granules for further processing;
(h) Optionally, milling of the oversized dry granules from step (g) in an appropriate mill and recycling the milled materials to step (c);
(i) Optionally, screening the undersized dry granules from step (g) in an appropriate screening apparatus with the undersized granules recycled to step (c) and the remaining sized granules introduced to step (j) for further processing or optionally a portion retained as a screened granular product;
(j) using an appropriate solid-liquid mixing vessel, mixing the sized granules from step (i) with a pre-determined amount of precursor mineral mixture, and optionally a pre-determined amount of one or more additives, while moisturising the mixture with a pre-determined amount of water to produce wet sheets comprised substantially of sized granules; and
(k) allowing the sheeted product from step (j) to set and dry in open air to produce dry sheet products.

Depending on the quality of waste paper and/or cardboard used and the intended applications of a product, step (b) of the process may optionally be followed by heating of the screened dry pulp or chippings to a pre-determined temperature in a pressurised vessel to eliminate microbial contaminants.

The precursor mineral mixture is comprised of finely ground bassanite, magnesia and arcanite which minerals can be advantageously sourced from non-depletable resources such as seawater and brines from desalination plants and inland salt lakes.

The key steps of the method for producing a product from a feedstock materials of the present invention will be described below.

Dry Defibring/Chipping and Screening to Produce Dry Pulp or Chippings

In this step, the dry waste paper and/or cardboard (commonly sourced as bales or in bulk) is subjected to comminution by pulping/chipping, using an appropriate apparatus for defibring or chipping waste paper or cardboard to pieces, generally less than 10 mm across for use in production of feedstock materials of the present invention. The apparatus for producing fibrous pulp or chippings may include a commercially available fibre opening apparatus or a shredder, such as those used traditionally in textile and paper manufacturing industries. The commercially available dry defibring apparatus commonly include one or more wires wound around the rotating members, or wire mesh disks or blades with teeth, and may also have projections around the main shaft by which the rotating members engage paper/cardboard fibers, thus tearing them apart for lowering the density.

The purpose of the defibring/chipping apparatus of the present invention is twofold, firstly to substantially increase the volume of the fibrous and loose materials by reducing the density of the highly compressed fibre of the paper and/or cardboard. Secondly, to provide an ideal additive to the mineral mixtures of the present invention for producing high strength and lightweight feedstock materials, in the form of wet aggregate, wet granules and sheet containing granules for manufacture of diverse industrial products and consumer goods. These objectives are achieved by the inventors through the design and use of a purpose built defibring/chipping apparatus, as further described below. The apparatus of the present invention is capable of lowering the density of the paper and cardboard, supplied as bales or in bulk, by at least 70% in conjunction for use as an ideal medium to be bound with binders of the present invention for manufacture of wide range of products and goods commensurate with specifications compatible or even better than those of comparable products and goods.

Accordingly, the purpose-built defibring/chipping apparatus includes three main components including feeding, defibring and pulp discharge/storage. The apparatus may also include a screening component (i.e. a conventional magnetic screener operating upon a conveyor belt) for separating metallic/plastic impurities (staples, pins and plastic labels and packaging tape materials, etc.) and optionally a heat induced disinfection component for further treatment of the pulp/chippings before discharge in a storage vessel for subsequent use. The feeding component is a hydraulically operated metal frame to accept and feed the standard size bales or bulk to the defibring component, with the latter comprised of two or more rotating members with angled teethed blades and/or wire brush blades turning counter-clockwise towards each other. The blades are made from a materials that enables effective defibring with the least replacement requirements, such as iron, steel, aluminium, or a combination thereof and may be bent and arranged along the length of rotating shaft in any angle but at a pre-determined distance from each other in order to maximise engagement with pieces of paper/cardboard for tearing them apart into a desired particle size. The inventors have found that a defibring/chipping apparatus with multiple rotating members, made of steel or aluminium wire brush with one or more projections of varying dimensions that are welded randomly to the shaft of each rotating member, when operated counter-clockwise, are particularly suitable for producing substantially fine particles of fibrous materials of pre-determined size. The fine fibrous materials produced by such an apparatus is comprised of an assemblage of loose fibres separated into individual strings of fibres with the individual fibres, for example, having length to width ratios of 25:1 or greater for a specific application but not longer than 5 mm along the C axis.

It is to be understood that the details of the apparatus disclosed in this embodiment are merely exemplary as the invention may be embodied in various and alternative forms without departing from the spirit and scope of the invention. One skilled in the art will be able to appreciate the disadvantages of traditional wet repulping of old paper/cardboard which are known to consume large volumes of water (dry fibre concentration in water is between 5% and 15%) and thus are generally energy intensive and waste generating, regardless of the process and equipment arrangements and the type of energy and chemicals used for hydration, disintegration and dehydration steps.

Further, the method of the present invention provides pulp or chippings ideal for making aggregates and granules of any size, density, specific gravity, hardness, shape or surface textural features (such as smoothness and glossiness) for desired applications.

Solid-Liquid Mixing and Drying to Produce Aggregate Products

Aggregation is a surface physical-chemical reaction and is dependent upon the surface tension of water and capillary action between the precursor mineral mixture, pulp and/or chippings, and additives optionally included. It is a phenomenon advantageously used in this invention for the manufacture of a wet aggregate, which may be either further processed for value adding or directly dried to produce dry aggregate products such as goods packaging fillers. In the present invention, the physical-chemical reaction causes diagenetic formation of syngenite mineral that adheres to and acts as an effective binder of the aggregates formed from mixing of the mineral mixture with dry pulp/chippings in presence of water. The aggregate thus formed, quickly obtains form stability while continuously dehydrating because of constant agitation of the individual aggregates in the mixing vessel, being in direct contact with air, at room temperature.

This aggregation phenomenon may be achieved using a commercially available high shear solid-liquid mixing apparatus comprised of one or more mixing vessels with scrapping blades and optionally equipped with controlled-speed agitators which may preferentially have provisions for moving around and to tilt to any angle.

The mixing apparatus of the present invention can be advantageously designed to include a single storage container for receiving aggregates from all mixing vessels so to achieve a desired production capacity while operating either continuously or in batch production.

Because of the flexibility in the design of the solid-liquid mixing apparatus of the present invention, the solid-liquid mixing process can be performed in different manners, including different steps of addition of the dry pulp/chippings, precursor mineral mixture, additives and water to the mixing vessel. Furthermore, water can be added directly or sprayed upon the solids to adjust the extent of moisturising of the solids to achieve the desired physical-chemical reactions for use in producing the intended product stream.

Typically, the operation of the solid-liquid mixing apparatus of the present invention will be automated to include addition of pre-determined amounts of the solids for optimum mechanical and integral mixing in the apparatus, whilst being sprayed with a pre-determined amount of water to moisturise the resulting aggregates. The automated process is performed for a set time using water having room temperature, after which the wet aggregate is discharged into a holding vessel before either drying in a conventional drying vessel to produce a final aggregate product or directly transferred to granulating apparatus further processing. In an automated mode of operation, it is possible to optimise the production output by adjusting the amount and volumes of inputs of the materials (pulp/chippings, precursor mineral mixture, additives and water), mixing speed and humidity of the materials in the mixing vessel.

Furthermore, the flexibility offered by solid-liquid mixing apparatus of the present invention provides added advantages for some applications, wherein aggregates of specific size, density, graininess and surface textural features are required. Such applications, as described in the following embodiments, may include plantable containers, grow media for urban and indoor farming, odour control media and fillers for goods packaging.

The wet aggregate produced in the present invention can be dried to produce dry aggregate products described in the following embodiments. Drying is achieved either by drying in open air, which may be aided by hot air blowers or in a drying room/cabinet at moderate temperatures, or a combination of both.

Generally, the hydration and carbonation reactions, caused by solid-liquid mixing in room temperature, lead to formation of the aggregates dominated by gypsum and syngenite minerals, and to a lesser extent, magnesium hydroxide and sulphates. Laboratory observations supported by petrographic information point to syngenite as the dominant fast-setting binder, which is disseminated throughout the structural matrix of the mineral aggregate, making the aggregates containing waste paper/cardboard of the present invention self-binding and highly settable for use in the mass manufacture of aggregated, granular and sheet products.

In light of the foregoing, a person skilled in the art would be able to determine, using no more than routine trials, the amount of water required for producing aggregates with adequate rheological properties and workability, for any given precursor mineral mixture, type of water and the desired product. As a general rule, using a minimum amount of water will reduce the need for evaporative dehydration by subsequent heating, consequentially reducing the cost of manufacturing. Nevertheless, the feedstock materials of the present invention, namely the wet aggregate, granules and sheet containing granules require far less water, even less than the lowest range of water consumption in pulp slurries used to make paper and cardboard products, which generally contain over 80% water by volume.

Aeration

In some embodiments of the present invention, air may be blown into a wetted mineral mixture before it is mixed with dry pulp/chippings, for the purpose of increasing the porosity of the produced wet feedstock materials. The cellular products produced by this method are substantially lighter than their non-aerated counterparts, with weights typically being 20% to 50% lighter. The amount of water required to produce cellular wet aggregate is also substantially lower than their non-aerated counterparts.

Any suitable technique may be used to aerate the mixture. For example, the wetted mineral mixture may be aerated with air, using an appropriate aeration apparatus prior to mixing with dry pulp/chippings in a high-shear mixing vessel.

Incorporating air or gas voids within the structural matrix of products, without compromising their strength, is a highly desirable feature (particularly for density reduction) in production of wet aggregate for mass manufacture of products such as agricultural, containers, goods packaging fillers and odour control media. Aeration also leads to substantial efficiencies in labour and energy costs while the continuity of air or gas circulation prohibits algal growth in the products of the present invention. Aeration of the wet aggregate of the present invention can be achieved using several conventional aeration techniques, used in food and mineral processing industries and contrary to existing practices, no stabilising agents, pH adjustment heating during moulding, etc., are required in the present invention to aid the incorporation and retention of air voids in the wet aggregate.

Retarding Agent

In some embodiments of the present invention, a retarding agent effective to slow curing/setting time, and hence improving the workability of the aggregates containing pulp/chippings, may be added during stirring. Retarding agents may also provide additional benefits such as improved fluidity, pH stability and anti-sag performance of the aggregate feedstock materials prior to manufacturing products.

Any suitable retarding agent may be used, such as a weak acid (e.g. acetic acid, citric acid, tartaric acid, ascorbic acid, boric acid, sodium gluconate, phosphoric acid and several degradable derivatives of the phosphoric acid). The use of cheap and widely available food grade vinegar (a form of acetic acid) has, for example, been found to be particularly effective for improving the workability of the aggregate feedstock materials used for the manufacture of for example, agricultural and ornamental containers. As further elaborated in the following embodiments, retarding setting time would be particularly useful during the stage of screening large and small granules for producing sized granules.

The setting time, involving both the initial and final setting time is closely related to changes in the rheological properties of precursor mineral mixture in the mixing vessel, after adding water. Using retarding agents, the setting time of the aggregates of the present invention can be extended up to 3 times of its original setting time. The amount of a retardant to be used will vary according to microstructural engineering and manufacturing requirements and will depend on the precursor mineral mixture and the additives included in the mixture and water.

Agglomeration to Produce N-P-K Pellets and Method of Use

As detailed in a previous embodiment, a method for producing nutritive pellets (referred to as “N-P-K pellets”) comprised of a predetermined mixture of mono ammonium phosphate (MAP) or diammonium phosphate (DAP) and arcanite is provided. The N-P-K pellets produced according to teachings of the present invention contain the three key nutrients of plants in the form of two highly soluble yet unreacted minerals (MAP/DAP and K₂SO₄) in discrete pellet form with a thin rim of the feedstock materials of the present invention formed around the MAP/DAP and arcanite (K₂SO₄) mixture during the agglomeration process. The addition of these pellets and their incorporation into the feedstock materials can be precisely controlled to produce products with a controlled rate of degradation of the container.

As used herein, the term “pellet” relates to a preformed and shaped materials having relatively uniform dimensions in a given lot, and holding this form until its incorporation in the mineral mixture prepared for use in production of agricultural containers. Neither the shape or size of the pellets are limiting factors in the present invention; pellet shapes can be cylindrical, spherical or any other shape, and the ratio of mineral mixture to total amount of MAP, DAP and potassium sulphate can be conveniently adjusted to provide favourable operating conditions and curing time. As further described in the following embodiments, the N-P-K pellets of the present invention can be used as an additive in predetermined amounts in manufacturing of a variety of agricultural products, where the amount of soil-available nutrients is a prime requirement, such as seedling and hydroponic containers.

Methods to Accelerate Product Hardening Time

In some embodiments, the hardening time of the products of the present invention can be accelerated/shortened for the purpose of reducing manufacturing time and cost of the feedstock materials, without compromising its structural integrity and degradability. An accelerated hardening time might be achieved by means of (a) micronisation of the constituents of the precursor mineral mixture, (b) increasing the amount of arcanite at the expense of bassanite in the mineral mixture, (c) seeding via an aforementioned embodiment, or (d) combinations thereof.

In method (a), the constituents of the precursor mineral mixture are even more finely ground, such that they become micronised, which further increases particle packing density and reactive surface area of individual particles, while reducing the ratio of inter-particle water content in the feedstock materials to that of syngenite binder that is diagenetically precipitated in the structural matrix of the moulded article. In this method, the particle size of finely ground individual constituents of the mineral mixtures may be further reduced by an appropriate micronising.

In method (b), an accelerated hardening time is obtained by reducing the ratio of gypsum to syngenite present in the feedstock materials by increasing the amount of arcanite at the expense of bassanite in the precursor mineral mixture. Such an adjustment in the ratio of the components of the mineral mixture advantageously causes faster binding and initial hardening effects, due to presence of a higher percentage of syngenite binder in the feedstock materials, at the expense of lower gypsum percentage. The hardening process of this method does not require any additional rheology-modifying binding agent.

In method (c), seeding can be used to accelerate the hardening without compromising the structural integrity and degradability of products such as plantable containers and garden products.

The reduction in the overall hardening time of the moulded products using these methods (and without using any external heating source or chemical additives) can be significant, depending on the type and amount of fillers and colouring agents added to the mineral mixtures. A person skilled in the art can apply these methods in various combinations to determine an optimum hardening time for any given product and feedstock materials.

As commonly known, the ability to rapidly harden an article is a major consideration in the microstructural design and economics of mass manufacturing of a number of products of the present invention such as plantable containers, packaging fillers, soil conditioners and garden products. The hardening time of the products of the present invention can be shortened without the need for heating of either the moulds, nor the demoulded articles. Furthermore, they are produced in a form ready for proceeding through the remaining manufacturing processes, i.e., printing, coating, painting, engraving and packaging in the case of plantable containers. The above-mentioned advantages of accelerated hardening of aggregates of the present invention provide distinct handling, manufacturing time and cost advantages to the products of present invention, particularly for plantable containers requiring high water retention capacity for use in hydroponic application.

Shaping the Forming Feedstock Material into a Shape of the Product

Once the diagenetic reactions described above are underway, the intermediate feedstock material is shaped into a shape that approximates that of the product that is desired to be formed. As described herein, a specific application of the present invention relates to the production of plantable containers for plants and hence, the feedstock materials may, for example, be shaped into the shape of a container for plants. It is acknowledged that slight changes in shape may occur as the product dries out, but these can easily be accounted for in the design process.

Any suitable shaping apparatus and process may be used. Typically, however, the feedstock materials would be shaped into the shape of the product by pouring into a mould. In some embodiments, conventional compression moulding apparatus can be used for mass manufacturing plantable agricultural containers, where the feedstock materials are placed into an open outer (female) mould before the inner (male) mould is compressed upon the outer mould to provide a closure under pressure and force the materials to contact all areas of the moulds without heating the mould cavity. Throughout the process, the pressure is maintained until the feedstock materials has set and the feedstock materials formed, after which the inner mould is released and the moulded product is removed for hardening at room temperature or by accelerated drying using a low temperature heat source.

In another embodiment a conventional injection moulding apparatus can be used for manufacture of degradable products such as plantable agricultural containers. In such embodiments, the well-mixed feedstock materials are injected via a barrel by force into a mould cavity, where it sets in the configuration of the cavity before its removal for hardening at room temperature (or by accelerated drying using a low temperature heat source). Because of high workability of the feedstock materials of the present invention, the moulds for both compression and injection moulding can be easily designed by a design engineer and made by a mould-maker with relevant tool making skills. The choice of moulding method is dependent on the constituents of the mineral mixture and desired functionality, ergonomics and aesthetics of the final article. The inventors note that these moulding methods can be used to manufacture a variety of plant containers, from small and simple grow cubes to the entire body of highly functional complex-shape plantable agricultural containers, with a high degree of dimensional accuracy with short cycle time. As would be appreciated, such would be competitive with the mass manufacturing utilised to produce conventional plastic plant containers.

Shaping of the forming feedstock into granular products and apparatus used thereof are described in the following embodiments.

Allowing the Shaped Feedstock Material to Set, Whereby a Product is Formed

Once shaped, the feedstock material is allowed to set, whereupon a product is produced. The setting time of the feedstock materials of the present invention is dependent on the content of water and seeding agent(s) added to the mineral mixture, the reaction temperature and mixing conditions at the time of reaction. In some embodiments (especially those where an excess of water was used, or where a more rapid drying time is required), the feedstock materials may be set by heating to an elevated temperature (e.g. up to about 60° C.), although this would increase the energy requirements and hence cost of production so may be undesirable. In alternative embodiments, therefore, the feedstock materials may set by allowing it to dry at room temperature for about a week.

Granulating the Wet Aggregate and Drying to Produce Granular Products

Granulation is another surface physical-chemical reaction and is dependent upon the surface tension of water and capillary action between diagenetically formed binder from precursor mineral mixture and dry pulp or chipping particles. This phenomenon is advantageously used in the present invention for production of wet granules, which granules upon drying can either be used as granular products for specific applications or subjected to further processing for value adding, such as sheet production as further described in the following embodiments. In the present invention, the physical-chemical reaction phenomenon is achieved by diagenetic formation of syngenite mineral that adheres to and acts as an effective binder of the pulp/chippings in the aggregate from which granules are progressively formed in presence of water by tumbling in an appropriate orbital granulating machine operating at a pre-determined angle and tilted along its long axis. The granules thus formed quickly obtain form stability while continuously dehydrating because of the constant tumbling of the granules that are in direct contact with air at room temperature.

The wet granulation apparatus suitable to produce granular aggregates may, for example, be a conventional rotating bottle, a rotary drum granulator or other pellet making apparatus, such as a tumbler or pan or disc granulator/pelletiser, commonly used for granule or pellet production in chemicals and fertiliser industries and mineral processing operations. Preferably, a wet granulation apparatus developed by the inventors of the present invention and comprised of one or more purpose-built bowls (automated-or loader-fed feedstock materials) or alternative double conical frustum-shaped mixer with capability for tilting orbitally along the long axis (such as a titling concrete mixer) may be used. In principle, the mixing component of the invented granulation apparatus functions similar to tilting drum concrete mixers available in the market. The wet granulation apparatus of the present invention can be advantageously designed to have any desired production capacity using a discharge outlet either at the tail end of the long axis or at the top opening of each tilting drum/bowl for multiple discharge of granules for operation in both continuous and batch modes. The major components of the wet granulation process of the present invention may include a paddle/pin mixer, wet granulation apparatus as described above, vibrating screen, oversize mill and surge hopper. Where the wet granules produced form the process are to be used as a final product (such as decorative granules), the wet granulation process can be linked directly with a rotary dryer via a transfer conveyor to produce dry granules.

Because of the flexibility in the design of the wet granulator of the present invention, the solid-liquid mixing process can be performed in different manners, including different steps of addition of dry pulp/chippings, precursor mineral mixture, additives and water to the drum vessel as it revolves at a pre-determined speed and angle. Furthermore, water can be added directly or sprayed upon the solids to adjust the extent of moisturisation of solids to achieve the desired physical-chemical reactions for the intended product stream. Optionally, wet mineral mixture, preferably produced in slurry form can be aerated by injecting air directly into the slurry prior to its introduction to drum vessel, wherein pulp/chippings are added before adding water directly or sprayed intermittently to produce granular feedstock with desired porosity.

Typically, the operation of the granulation apparatus of the present invention will be automated to include pre-determined amounts of the solids for optimum mechanical and integral mixing in the apparatus, whilst being sprayed with a pre-determined amount of water to moisturize the resulting granules. The automated process is conducted for a set time using water having room temperature, after which the wet granules are discharged to a holding vessel before drying to either form a final granular product, or further processing whilst the rotating drum is loaded with a new batch of materials for processing. Because of the automated operation it is possible to optimise the production output by adjusting the amount and volumes of input materials (pulp/chippings, precursor mineral mixture, additives and water), mixing speed and angle of rotation and humidity of the materials in the rotating drum.

The granulation process can also be advantageously performed in combination with seeding, as described above, by incorporating seeding agents such as fine pulp having elevated length:width ratio aspects, the precursor mineral mixture, or a combination thereof. The fine pulp can include pulp prepared from intensely defibrised waste cardboard or any organic fibrous materials which can produce similar aspects, including but not limited to coir, hay, straw, etc. upon prior crushing and sieving to achieve a desired particle length:width ratio before use. Generally, the amount of seeding agent may determined in prior by a small trial, but as an indication, it can be added in predetermined amounts (w/w), relative to total weight of the precursor mineral mixture

A combination of granulation and seeding method enhances the equilibrium between surface tension of water and capillary action between the pulp/chipping containing particles, and can therefore effectively reduce the overall granulation time while enabling the production of purpose-made granules for diverse industrial and consumer good applications. In this context, in some embodiments colour pigments, surfactants or various combinations may be applied as optional additives to further enhance the shape (i.e. roundness of the individual granules) and surface textural effects (i.e. smoothness and glossiness) of the resultant granules. The surfactants can be selected from a range of degradable, non-ionic and cationic varieties, with sodium dodecyl sulphate (SDS) and Sodium laureth sulfate (SLES) found by the inventors particularly suitable for producing large equi-size granules.

Furthermore, the granulation apparatus of the present invention, in addition to its flexibility with operating procedures, can provide added advantages for some applications, wherein wet granules of specific size, density, porosity and surface textural features are required. Such applications, as described in the following embodiments, may include granules and pebbles for goods packaging, compost amendments, soil conditioners and decorative garden products, to mention a few. In such applications, the earlier produced granules (either in wet or dry form) may be further granulated using the apparatus of the present invention, optionally using a fresh combination of dry pulp/chippings, precursor mineral mixture and additives which additives may include surfactants for improving bonding effects of particles in the recycled granules. The granulation process of the present invention also enables the advantageous use of gypseous and non gypseous plasterboards and other solid waste from construction, renovation and demolition (CRD) industry as a core (nucleus) for encapsulation through the use of feedstock materials in a granulated apparatus of the present invention.

The wet granules produced in the present invention can be dried to produce dry granular products described in the following embodiments. Drying is achieved either by drying in open air which may be aided by hot air blowers or in a drying room/cabinet at moderate temperatures, or a combination of both.

Resizing Granules to Produce a Desired Sized Granules (Optional)

In some embodiments the oversized and undersized dry granules from the granulation process may optionally be recycled to solid-liquid mixing vessel to produce dry granules of particular size range for use for in manufacturing products/goods for specific applications. A conventional milling apparatus (with an appropriate particle sieving/sorting attachment) may be used for reducing the size of the oversized granules prior to reporting solid-liquid mixing apparatus. The dry granules from the process may optionally be screened in a vibratory sieve system to separate and recycle the undersized granules to solid-liquid mixing vessel.

The resultant sized granules, produced according to teachings of the present invention, are found by the inventors to be ideal for manufacturing certain products and goods where size and granularity are of prime importance for product functionality, such as goods packaging fillers and soil conditioners, grow media and decorative garden pebbles and granules.

Solid-Liquid Mixing of the Sized Granules, Precursor Mineral Mixture and Water to Produce Sheet Products

In some embodiments, with reference to earlier embodiments, the dried granules may optionally be subjected to further solid-liquid mixing in room temperature with pre-determined amounts of precursor mineral mixture, water, and optionally one or more additives in an appropriate mixing vessel to produce a wet sheet. The wet sheets thus produced are air dried to produce sheet products for diverse applications (described below) with soil conditioning effects being the primary objective non-mulch sheet products. As described in an earlier embodiment, dry granules of particular size ranges, for manufacturing sheet products for specific applications, can be conveniently produced by recycling, using a combination of appropriate milling and sieving apparatus prior to reporting to solid-liquid mixing apparatus. Additives may include colourants (for colour coding of the sheet products), one or more nutrient elements or a combination thereof, such as N-P-K pellets, or any other additive to enhance the functionality and form stability (i.e. for application to sloped terrains) of the sheet products. A mobile spray vessel, such as a truck fitted with jet spraying equipment, may be used for large-scale spraying of a slurry made from mixing of precursor mineral mixture, water and optionally one or more additives onto an already laid granular bed.

Because of flexibility of the manufacturing process the thickness, texture, form stability, degradability, functionality (i.e. water retention capacity, aeration, nutritive value for receiving soils, etc.) of the sheet products can be optimised by repeating the step of mixing of sized granules with a pre-determined amount of mineral mixture or by adjustment of the composition of the precursor mineral mixture and type and amount of additives.

Industrial Products and Consumer Goods Made from Waste Paper/Cardboard

In some embodiments, the present invention may provide feedstock materials in the form of wet aggregate, wet granules and wet sheet containing granules may provide or be used to manufacture a wide range of industrial products and consumer goods, wherein waste paper/cardboard comprises a significant bulk volume of the products without compromising the strength, structural integrity, functionality or degradability of the said products and goods. Without limitation, the application areas and production methods of the products and goods are described below, with reference to Table 1.

TABLE 1
Examples of application areas of feedstock materials of the present invention

| Product Type | Applications | Feedstock material type |
|---|---|---|
| Plantable containers | Horticulture, agriculture containers | Wet aggregate |
| for plants | Seedling/nursery containers | |
| | Containers for forestry, | |
| | landscaping and mine site tailings | |
| | vegetation | |
| Granular and sheet | Sheet containing granules as a | Wet granules & wet |
| mulch | mulch | sheets |
| Soil conditioners | revegetating land divisions, | Wet granules and wet |
| | decommissioned landfills and | sheets |
| | brownfields, landscaping and | |
| | commercial orchards | |
| | Mine site tailing revegetation | |
| | Rooftop gardens | |
| | Containerised granular linked to | |
| | building stormwater pipe for | |
| | watering and nutrient release | |
| Media for odour | Malodour generated by: | Wet aggregate |
| control in food | Poultry, piggeries, cattle farms, etc | |
| production, | Agri-food (vegetables and fruit) | |
| consumption and | food consumption (household, | |
| food waste | restaurants, military, cafes, grocery | |
| management, | stores, schools, hotels, cruise and | |
| | cargo ships, hospitals, etc) | |
| | food waste management (including | |
| | composting, garbage collection, | |
| | waste management centres) | |
| Fillers for goods | Goods packaging fillers | Wet aggregate and wet |
| packaging and | Padded envelope fillers | granules |
| padded envelopes | | |
| Decorative pebbles | Decorative garden pebbles | Wet pebbles |
| | Decorative garden pebbles | |
| | incorporating/containing recycled | |
| | materials from construction, | |
| | renovation and demolition | |
| | activities. | |
| Composting | Composting amendments from: | Wet granules, Wet |
| amendments from | Agri-food (fruit cuttings vegetable | aggregate |
| food waste | skin, flower cuttings & garden | |
| | cutting), | |
| | fish, meat, | |
| | dairy products | |
| | other kitchen food waste | |
| | Hotels | |
| Grow media for | (Non-hydroponic) Controlled | Wet aggregate and wet |
| urban and indoor | Environment Agriculture (CEA) | granules |
| farming | grow media, | |
| | greenhouse/glasshouse | |

Plantable Containers for Plants

In some embodiments, the feedstock materials of the present invention in the form of wet aggregate may be applied for manufacture of a range of plantable containers for plants according to the process steps described in earlier embodiments.

Functional features common and advantageous to these containers are high water absorption and retention capacities. By definition, water absorption capacity (WAC) refers to the weight percentage of water held by a container (or, more generally, a product), and water retention capacity (WRC) refers to volumetric capacity of a container to hold water absorbed by the body of the container for a period of time until the container reaches its original dry weight including free water. WRC is expressed in total number of days taken by a products to reach its original dry weight at room temperature.

In some embodiments, the wet aggregate may be used to manufacture degradable plantable agricultural containers, wherein the walls and base of the containers have high WAC and WRC, such that they act as a slow release carrier of water, but without compromising the structural integrity or degradability of the container. The WAC and WRC values are dependent on a number of micro engineering design and manufacturing variables, with the key ones being the volumetric ratio of the pulp/chippings to that of precursor mineral mixture, the body thickness of the container, as well as the type and amount of additives (colourant/coating agents) used in the manufacturing process. The containers of the present invention generally have water absorption values in excess and 50%, with corresponding water retention values in excess of week.

Manufacturing uncoated agricultural plant containers having high water absorption and retention capacities can be accomplished using a number of conventional container manufacturing methods briefly described below. As described in the following embodiments, the feedstock materials of the present invention advantageously enable the use of aeration and agglomeration processes, in various combination with conventional container manufacturing processes and equipment, to produce products with enhanced functionality, appearance and versatility; features that are unmatched by conventionally manufactured containers. Features considered by the inventors of this invention as exclusive to the containers of the present invention, such as granularity or cellular body textural effects, may be advantageously used in the manufacturing process to conveniently adjust the WAC and WRC for providing a balanced soil moisture in the plant containers. As further elaborated in the following embodiments, the granularity or cellular body textural effects can be also advantageously utilised by the artisans to produce artwork with special aesthetic effects.

Agricultural containers manufactured using the degradable feedstock materials and teachings of this invention also offer a number of environmental benefits that are unmatched by agricultural containers of prior art as described below.

Firstly, existing plant containers produced from pressed paper/pulp, coir, peat, etch and held together by a binder require a high drainage rate through a bottom aperture to avoid buckling of the paper materials. In contrast, containers of the present invention retain their form until placed in soil to degrade over a period of time due to the interaction of physical, chemical and biological processes and their residues become soil conditioner. The extent of degradability and soil conditioning effects can be optimised by adjusting the proportion of additives, the techniques used to make the containers (agglomeration, aeration, seeding, etc) or any combination which through micro-engineering design and experimentation confirms having beneficial effects on the structural and functional properties of the containers. The bulk of generated residue is comprised of the least soluble mineral components, namely gypsum and magnesium hydroxide and fibrous materials from degradation of pulp/chippings, which are well known for their soil conditioning and composting effects. Consequential to the above-mentioned degradation processes, the nutrients (K, Mg, N, P, Ca, S) released from the disintegrating containers provide added nutritious effects to surrounding soils. The containers not transferred to soil or reused can be physically broken down into pieces and either discarded in soil or safely disposed in a landfill.

The containers remain form stable and structurally resistant to breakdown and adequately perform their intended containment function, provided that they are not exposed to the interactive forces of physical, chemical and biological processes in a soil environment. However, once the containers are transferred to soil, the observed sequence of events leading to degradation of the containers include:
repeated change in the body volume of the containers due to alternate expansion and contraction driven by alternate wetting-drying cycles in the vadose zones of the soil profile;
selective dissolution of a lower mass of water soluble sulphate minerals (syngenite and magnesium sulphate) intermixed with a significantly lower solubility gypsum mass;
where N-P-K pellets are included in the feedstock materials, development of secondary porosity and permeability zones within the structural matrix of the containers due to selective dissolution of N-P-K pellets which secondary porosity and permeability zones act as conduits for fluid flow and plant root penetration;
plant root growth through the walls and base of the containers, together with soil pressure and other environmental forces progressively causing breakage, accelerating physical-chemical processes, leading to pulverisation of structural matrix into a residual powder;
release of minerals and nutrients to surrounding soils under continued wetting-drying cycles prevailing in the soil profile;
progressive integration of the less soluble minerals (gypsum and magnesium hydroxide) and fibrous residue in the soil profile providing conditioning effects to surround soils

Secondly, crops planted in other types of conventional containers (e.g. such as those made from plastics, polymers, organic fibres and paper) can quickly dry out if not watered often and enough. Further, the waste water generated by nurseries due to excess watering of plants cultivated using conventional containers can lead to multiple issues such as high water usage, nutrient runoff to waterways and salt build up in fibre-based containers. In contrast, containers of the present invention can be manufactured with elevated WRC without adverse effect on their structural integrity for the purpose of substantial reduction in watering need and frequency, and thus an effective reduction in nutrient runoff.

The containers can be planted directly into the soil or, optionally, contain one or more plants initially grown in other containers before planting into the soil. The containers are suitable for providing continuity in cultivating plants such as seedlings, cuttings, rooted cuttings, plug plants, vegetables and/or pot plants, or plant materials (e.g. seed materials). The containers may be used for cultivating plants from seed and propagation to mature growth stage, thus obviating the need for transplanting and transfers in a variety of agricultural, landscaping, forestry, mine tailings vegetation and hydroponic/rooftop gardening applications. The containers can be configured to contain a single plant or a plurality of plants, with the plants spatially distributed to promote health of the plants free of competition for space, nutrients, moisture or light.

The containers are provided with a cavity for holding plant materials. The cavity has sidewalls and, optionally, a bottom portion that may include one or more apertures for drainage. The containers can be manufactured in sizes commonly used in commercial nurseries, broad acre production (short-term production), as well as in larger sizes suitable for woody nursery production (long-term production) which may include ornamental plants. The containers can be manufactured having a hollow body portion with or without a means for closure, depending on the extent of drainage and degradability requirements. The forestry, mine site tailings revegetation and landscaping tubes can incorporate a semi closure in the form a mesh base or a degradable fabric, such as jute, which is inserted at the bottom of the tube.

Thirdly, apart from waste paper/cardboard, the precursor minerals for producing degradable feedstock for manufacture of agricultural containers, according to teachings of the present invention may be sourced from widely available and replenishable mineral resources as well as from seawater to avoid severe ecosystem disturbance.

Agricultural containers of the present invention that can be generally used by nurseries and household gardeners include grow cubes, seedling trays and nursery pots as well as seedling containers for landscaping and containers for forestry/mine site tailings vegetation, and rooftop garden containers.

Nursery/Seedling Containers

In some embodiments, the present invention provides self-binding and fast setting feedstock materials that can use conventional moulding apparatus for manufacture of degradable seedling containers commonly in nurseries, that can be planted directly into the soil or optionally contain one or more plants initially grown in other containers before planting into the soil. The said containers are suitable for providing continuity in cultivating one or more plants such as seedlings, cuttings, rooted cuttings, plug plants, vegetables and/or pot plants, or plant materials (for example seed materials). The containers may be used for cultivating plants from seed and propagation to mature growth stage, thus obviating the need for transplanting and transfers in a variety of agricultural, landscaping, forestry, mine tailings vegetation and hydroponic/rooftop gardening applications. The containers of the present invention can be configured to contain a single plant or a plurality of plants therein, with the plants spatially distributed to promote health of the plants free of competition for space, nutrients, moisture or light.

The containers are manufactured from degradable feedstock materials disclosed in the foregoing embodiments and provided with a cavity for holding plant materials which cavity has sidewalls and a bottom portion; optionally containers can be made with a bottom. The bottom portion includes one or more apertures for drainage. These containers can be readily manufactured in sizes commonly used in commercial nursery, broad acre production (short-term production), and can also be manufactured in larger sizes suitable for woody nursery production (long-term production) which may include ornamental plants.

In one embodiment, conventional compression moulding apparatus can be used wherein the wet aggregate of the present invention are placed into an open outer (female) mould before the inner (male) mould is being compressed upon the outer mould to provide a closure under pressure and force the materials to contact all areas of the moulds without heating the mould cavity. Throughout the process, the pressure is maintained until the aggregate has set after which the inner mould is released and the moulded article is removed for hardening in room temperature or by accelerated drying using a low temperature heat source.

In another embodiment a conventional injection moulding apparatus can be used for manufacture of seedling containers of the present invention wherein the well mixed aggregate of minerals and pulp/chippings of the present invention is injected via a barrel by force into a mould cavity, where it sets in the configuration of the cavity and then removed for hardening in room temperature or by accelerated drying using a low temperature heat source. Because of high workability of the feedstock of the present invention, the moulds for both compression and injection moulding can be easily designed by a design engineer and made by a mould-maker with relevant tool making skills. The choice of moulding method is dependent on the constituents of the mineral mixture and desired functionality, ergonomics and aesthetics of the final article. Further, whereas other moulding methods can be applied by a manufacturer due to high workability and mouldability of the aggregates of the present invention, the aforementioned moulding method preferentially used for manufacturing a variety of containers, from small and simple grow cubes to the entire body of highly functional complex-shape plantable agricultural container with high degree of dimensional accuracy with short cycle time, typical of the mass manufacturing such as plastic agricultural containers.

Grow Cubes types of existing art include starter plugs which are a small solid growing medium for seed germination made from compressed paper, paper mulch and organic fibers, including peat. In one embodiment of the present invention grow cubes can be manufactured having a hollow body portion and may or may not have a closure means, depending on the extent of drainage and degradability requirements. Container shapes include cubic, elongated cubic, conical, funnel and cylindrical shapes in various sizes and wall thicknesses. In contrary to the grow cubes made from peat, the cubes made in any above mentioned shape from the feedstock materials of the present invention retain their structural integrity regardless of extent of wetting/drying and thus are reusable for multiple seedling cycles, thus adding to operational cost efficiency, reduced purchase cost to customers and substantially lower life cycle costs.

Seedling Trays of existing art are comprised of 2 or more cups, largely made from plastics and are used to grow multiple seedlings at once in a single tray before transfer to either larger containers/pots or transplanted to soil. Seedling trays of the present invention can have cups in various shapes including but not limited to cubic, elongated cubic, conical, funnel and cylindrical shapes which are perforated and may or may not have a closure means, depending on the extent of drainage and degradability requirements. The cups of the said seedling trays can be in various sizes and wall thicknesses depending on application; for example, the seedling trays having non-funnel shaped cups can be adapted for landscaping and forestry seedling applications by means of sharpened walls of bottomless cups for easy insertion into the landscaping or forestry soil.

Nursery pots of existing art are almost entirely made of plastics and polymers because of functionality and manufactured in various shapes and sizes having a bottom closure for housing larger plants grown beyond seedling stage but requiring growth before transfer to soil. Nursery pots of the present invention can be manufactured in various sizes and wall thickness fall into two categories; namely, bottomed pots with drainage hole and bottomless pots. In one embodiment, the horticultural pots can be made from standard aggregates disclosed in the first embodiment of the present invention using the aforementioned moulding methods to characterise with adequate structural integrity, consistent hardness and desirable functionalities including but limited to with high water retention capacity, nestability and eventual degradability upon return to soil.

Yet in another embodiment, because of the mouldability, fast setting and hardening characteristics, the aggregates of the present invention can be agglomerated or aerated before subjecting it to moulding in an appropriate moulding apparatus in order to produce nursery pots having increased water retention capacity, adjust the bulk density, obtain a desired textural appearance/aesthetics of the nursery pots or a combination thereof.

Additionally, nursery pots can be manufactured to include fillers and additives to provide a finished product that satisfies microstructural engineering design requirements and performance criteria, as well as improving the aesthetics of the nursery pots for wide ranging market applications. Furthermore, the wet aggregates of the present invention offer significant flexibility for use in manufacturing horticultural containers that accommodate plant cultivation needs from germination to seedling, plant growth to harvest stage wherein grow cubes, made from organic fibres or paper mulch as well as grow cubes of the present invention can be directly placed inside the said nursery pots to enable growth from seedling directly to mature stage without the need for transplanting.

In summary, the containers of the present invention can be manufactured in a range of capacities to fit many different growing needs of plant growth by accommodating/enclosing one or more single organic fibre or paper mulch based grow cubes, seed starting trays or seed propagation containers, thus eliminating the need for transplanting. Regardless of the size, shape and function, all containers of present invention become degraded upon return to earth.

The horticultural containers that can be manufactured in any desired dimensions using conventional moulding methods and the aggregates of the present invention. It is within the skill of a designer of horticultural containers of the art to determine the sizes and wall thicknesses of various of the containers to achieve the desired functionality and characteristics.

Grow Cubes for nurseries and gardeners can be in any size with H:D ratio ranging from as small as 1:1 to as large as 2:1 with the thickness of the cubes altered by adjusting the space between the male (inner) and female (outer) moulds to obtain the desired performance criteria without adjusting the makeup of the feedstock materials in order to accommodate a particular container thickness.

Seedling pots for landscapers and forestry planting can be in any size with H:D ratio ranging from as small as 2:1 to as large as 4:1. Seedling Trays for nurseries and gardeners can be in any size with individual containers within the tray having a H:D ratio ranging from as small as 1:1 to as large as 2:1. Nursery Pots can be in any size with H:D ratio ranging from as small as 1:1 to as large as 4:1.

The thickness of the aforementioned horticultural containers of any size and shape can be altered by adjusting the space between the male (inner) and female (outer) moulds to obtain the desired performance criteria without adjusting the makeup of the feedstock materials; however, most articles requiring thin walls such as grow cubes will generally have a thickness in the range from about 1 mm to about 4 mm. Nevertheless, in applications where higher strength or stiffness is more important, the wall thickness of the article may range up to about 5 mm. Within the scope of the present invention, seedling trays and pots can have greatly varying thicknesses depending on the particular application for which the article is intended. However, most such articles will generally have a thickness in the range from about 2 mm to about 5 mm. Nevertheless, in applications where higher strength or stiffness is more important, the wall thickness of the article may range up to about 12 mm.

Containers for Forestry, Landscaping and Mine Site Tailings Vegetation

In some embodiments, the present invention provides feedstock materials suitable for manufacture of degradable plantable containers for use in forestry, landscaping and mine site tailings vegetation programs, wherein the said containers can be directly inserted into the substrate, with or without a suitable insertion apparatus, to provide controlled irrigation and desired growth environment to plants within the confines of individual containers.

Forestry and landscaping industries are historically the largest users of plantable containers but, compared with nursery operations, require a higher degree of operational and watering efficiency as the use of conventional and modern irrigation practices, such as drip feed and foliar water and nutrient applications are not feasible due to the remoteness of forestry and large scale landscaping operations.

Mine site tailings rehabilitation projects are another large user of plantable containers that often because of elevated levels of toxicity, acidity and salinity of the mine tailings, also require a high degree of operational self-sufficiency and regular monitoring to ensure the success of a vegetation program in remote areas. Furthermore, because of inherited acidity of the mine tailings and the nature of disturbed underlying rocks, a comprehensive site preparation works including pH adjustment by limestone application is often necessary prior to implementing a large scale plantation.

The degradable containers for forestry, landscaping and mine site tailings vegetation applications can be manufactured from the aggregates of the present invention according to site or product specific requirements and considering micro engineering design parameters, such as the best fit formulation of feedstock materials, additives and other related factors affecting the rheology of the feedstock materials are optimised, as well as textural features (pore size, permeability, granularity and cellularity, wall thickness, etc) for achieving the desired water retention capacity in controlled irrigation environment.

In one embodiment, mouldable aggregates of the present invention, can be used to produce controlled irrigation agricultural containers for use in forestry, landscaping and mine site tailings vegetation applications. The containers generally used for planting seedlings for forestry and landscaping applications include plant tube pots, native tree tubes, super native tree tubes and cone-based tubes. Such forestry and landscaping containers can be conveniently manufactured in square, cylindrical, funnel and conical shapes and combinations thereof and are typically elongated with a pointed ending at the bottom for the purposes of propagating, seedling and growth of root cuttings. The tubes can be manufactured having a hollow body portion with or without a means for closure, depending on the extent of drainage and degradability requirements.

The tubes can incorporate a semi closure in the form a mesh base or a degradable fabric, such as jute, which is inserted at the bottom of the tube. Optionally the tubes can incorporate internal ribs for root training. Such conical tubes can be manufactured in various sizes and wall thicknesses can be customised but typically follow the D:H ratios in the range of 1:1 to 1:5 and wall thicknesses is the range of 3 mm-10 mm.

Containers in the form of conical tubes can be specifically designed for ease of handling and fast plantation (two highly desirable requirements in forestry and mine site tailings rehabilitation projects) using a commercially available or custom-built seedling jab planter. Round conical tubes with a side drainage hole are particularly suitable for direct insertion of planted seedlings or cuttings into soil directly in large numbers. Additionally, the tubes can also be designed and manufactured from aggregates of the present invention as trays of multiple tubes wherein each plantable tube is perforated along the top edge for ease of detachment for insertion into the substrate. The trays offer additional advantages of nestability.

In addition to advantage of ease of nestability the tubes and trays of the present invention, offer a unique advantage of degradability after insertion into the substrate via the interaction of chemical, physical and biological process disclosed in the following embodiments.

Plantable containers of the present invention can be designed and manufactured according to site and product specific needs of forestry, landscaping and mine site tailings vegetation programs, in order to provide multiple functionalities that in plurality lead to improved operational efficiency, currently unavailable with existing containers. These functionalities may include one or more of the following:
high water retention capacity containers in the ranges specified in previous embodiments which acts as a water reservoir for the contained plants thus leading to significant water saving and watering cycle efficiency, particularly for plantations located in water scarce areas subjected to salinity ingress;
containers with controlled water delivery protect the contained plants from problems associated with water-logging and aridity in remotely located operations or terrains with limited human access;
point positioning of seedling containers ensures healthy plant growth and optimised vegetation coverage;
containers obviate the need for broadcast application of fertilisers and mulch at early stages of plantation;
containers, having high water retention capacity are particularly suited for plants requiring coarse sandy and gravelly soils;
containers, having stable moisture and air regime in the contained soil and fertiliser provide highly favourable growth conditions particularly for rooting of plants from cuttings;
containers, having regulated water retention capacity offer efficiencies better than drip irrigation, which clog after long usage, and require much less water than foliar irrigation, particularly in with high evaporation rates;
containers protect root zone of seedlings in mine site tailings vegetation from plant diseases and pests, as well as from toxicity, acidity and salinity ingress from surrounding substrate;
containers can be used effectively for steep slope minesite tailings plantation programs; and
containers act as soil conditioner upon degradation.

In summary, the containers of the present invention can substantially reduce costs associated with materials handling, site preparation and planting operations in forestry, landscaping and minesite tailings vegetation programs due to the aforementioned functionalities. The high water retention capacity of the said containers obviate the operating issues such as the need for frequent watering during transport and delivery of the plants which negatively impacts the overall health of plantations.

Method of Cultivating a Plant in the Containers

A method for cultivating a plant in an agricultural container of the present invention may, for example, comprise the steps of:
placing a plant seed, seedling or a root cutting and growth medium in the container;
watering the container until the walls are wet which allows the container to hold water hence allowing less frequent subsequent watering intervals;
permitting germination of the plant seed, growth of the seedling or the plant in the container, and
permitting growth of the living plant in the container as a standalone pot; or optionally permanently transferring the cultivated container within soil, earth or mine tailings with the openings of the container below soil, earth or mine tailings surface to permit root growth from within the containment volume into the soil, wherein, after transplanting the container can degrade within the soil and provide conditioning effects to the surrounding soil.

The agricultural containers of the present invention are suitable for cultivating of various seedlings and plants regardless of the species of the seed, or the type, size and growth stage of the plant. The use of containers for cultivation of seeds and/or plants are independent of the characteristics of the medium used such as fertilizers, nutrient additives, mineral supplements, beneficial commensal microorganisms, and the like. If desired, the agricultural containers of the present invention can incorporate adequate amounts of pesticides, selective herbicides, fungicides or other chemicals to remove, reduce, or prevent growth of parasites, weeds, pathogens, or any other detrimental organisms. Furthermore, seedlings grown in grow cubes and plugs can be conveniently transferred to the containers of the present invention for further growth to avoid transplanting shock. Due to high water retention characteristics of the containers of the present invention plants cultivated in these containers can be packaged and colour coded prior to subjecting containers to prolonged storage/shipping without the need for refrigeration before delivery to final site or consumption.

Granular and Sheet Mulch

Mulching is one of the broadly used weed management methods in agricultural industries because when left on, applied to, or grown on the soil surface, it influences soil characteristics and discourages weed growth. Apart from acting as a weed management tool, different mulch types may offer other advantages to soils including controlled sunlight penetration, moisture retention, soil temperature modulation and thus help in soil health in terms of plant establishment and growth, as well as aesthetic appeal of the planted area and its surroundings. Mulch is commonly in bedded form and varieties include organic mulch such as turf, hay, straw, burlap, coffee bags, shells, wood products (i.e. bark, wood, arborist chips, deciduous tree leaves and sawdust), yard waste compost or a combination thereof. Non-organic mulch includes carpets, plastic sheeting, geotextile fabrics, rubber, crushed rock, gravel and cobbles. Commercial or agricultural by-products such as cardboard, paper waste and newspaper waste are also used to a lesser extent.

In some embodiments, a method for producing new mulch products (in granular or sheet forms) from the feedstock materials of the present invention is provided, wherein the additives include a pre-determined amount of a pesticide and the wet granules are dried in air or in an appropriate drying vessel to produce a dry granular mulch product. The additives may also include a colourant for colour coding the product in order to monitor the progress with granular mulch application stages. In other embodiments, the dry granules can be further treated to produce a sheet mulch products (also known as bedded mulch). For large-scale sheet mulch production and application, such as large land divisions or mine site tailings rehabilitation works, a mobile spray vessel, such as a truck fitted with jet spraying equipment may be used for spraying a thin slurry made from mixing of precursor mineral mixture, water and optionally one or more additives onto an already laid granular bed. The additives may include a colourant for colour coding of the product in order to monitor the sheet mulch application stages.

As indicated in earlier embodiments, the size of granules to be embedded in the sheet mulch can be optionally adjusted by a combination of recycling and screening step, Additionally, the wet sheet production step can be optionally repeated one or more times with the objectives of (a) producing a sheet mulch product of desired thickness (5-15 cm) and textural features commensurate with product quality and application site requirements and (b) adjusting the composition of the precursor mineral mixture to ultimately generate a degradation residue with enhanced conditioning and nutrition value to receiving soil and substrate.

The mulch produced from waste paper/cardboard, according to teachings of this embodiment, have features that can redress several disadvantages associated with mulch and mulch sheet products of prior art, including but not limited to, oxygen starvation, inner bark death of aboveground root flares, fungal and bacterial disease, excess heat, infiltration and deterioration by rodents, soil pH acidity changes and nitrogen deficiency. Additionally, some of the sheet mulch products, currently available in the markets, are known to prevent water movement and gas exchange once they become too wet or too dry. In the case of costly plastic mulch film, nutrients (such as organic carbon and nitrogen) of the soils overlain by such plastic film can be significantly declined, imparting long-term detrimental effects on soil quality and thus sustainability of the mulching practice. In contrast, the mulch products of the present invention are porous and aerated, and because of high water retention capacity and pH normalising effects of the aggregates, they avoid the abovementioned shortcomings with existing mulch products.

Additionally, the nutritious granules of the present invention reduce runoff and soil movement from garden beds and maintain temperature of the soil for effectively for plant growth. Further, being degradable with soil conditioning effects, they offer a low-cost and sustainable alternative to plastic and polymer-based mulch films having a major disposal issue, representing another compounding challenge yet to be addressed by industry.

In summary, following the global quest to create more sustainable landscapes, the use of sheet mulch of the present invention provides an excellent way to reduce weeds and maintain soil health in permanent landscapes.

Soil Conditioners

Soil conditioners of the present invention come in many forms and compositions, and are manufactured in different ways to satisfy application specific requirements. In one extreme, a variety of fibrous waste materials (such as waste wood fibre, papermill sludge, papermill flyash, biosolids and composted biosolids) have been applied for conditioning of mine tailings, either alone or as mixtures, with variable degrees of effectiveness, depending on nature of terrain applied (slope, particle size distribution and competence, salinity, acid-producing potential, sodicity, erodibility, water holding capacity, etc). Water holding capacity and fertility have been reported as the key measures for assessing the effectiveness of the soil conditioners applied for revegetating land divisions, de-commissioned landfills and brownfields, landscaping and commercial orchards. At the other end of the spectrum where the use of soil conditioners for creating a green space, such as domestic and rooftop gardens, aspects of soil conditioners such as drainage, aeration, water holding capacity and fertility of the ground have been reported as prime considerations.

The method of producing and using feedstock materials for producing novel granular and sheet soil conditioners of the present invention have properties comparable or even better than those currently commercially available, as discussed below.

In some embodiments, a method for producing granular soil conditioners from feedstock materials of the present invention is provided, wherein the additives include a pre-determined amount of MAP or alternatively N-P-K pellets and the produced wet granulates are dried in air or in an appropriate drying vessel to produce a granular soil conditioner product. The additives may also include a colourant for colour coding of the product to monitor the application areas and stages. In other embodiments, the dry granules can be further treated to produce sheet form soil conditioners. The additives may include a colourant for colour coding of the product to monitor the application areas and stages.

For small scale sheet conditioner production and application, such as domestic and rooftop gardening, a simple plastic or metal made garden watering can with a perforated discharge nozzle may be used for the spray of a thin slurry made from mixing of precursor mineral mixture, water and optionally one or more additives onto an already laid granular bed.

For large scale sheet conditioner production and application, such as commercial orchards, land divisions or mine site tailings rehabilitation works, a mobile spray vessel, such as a truck fitted with jet spraying equipment may be used for the spray of a thin slurry made from mixing of precursor mineral mixture, water and optionally one or more additives onto an already laid granular bed.

As indicated in earlier embodiments, the size of granules to be embedded in the sheet may be optimised by a combination of recycling and screening step. Additionally, both the granulation and sheet production steps may be repeated one or more times to produce granular and/or sheet products with increased thickness and textural features, commensurate with product quality and specific conditions for on-site production of sheet soil conditioners. Also, as indicated in earlier embodiments, the composition of the precursor mineral mixture can be optionally optimised to ultimately generate a degradation product (a residue) with enhanced conditioning and nutrition value to receiving soil or substrate.

The soil conditioners produced from waste paper/cardboard, according to teachings of this embodiment, have features that can redress several disadvantages associated with existing soil conditioner products, including but not limited to poor water and air circulation leading to oxygen starvation, inner bark death of aboveground root flares, fungal and bacterial disease, excess heat, infiltration and deterioration by rodents, soil pH acidity changes and nitrogen deficiency. Additionally, some of the sheet soil conditioners, currently available in the markets, are known to severely prevent water movement and gas exchange once they become too wet or too dry. In contrast, the soil conditioners of the present invention are porous and aerated, thus have pH normalising effects on the underlying soil/substrate. Further, because of high water retention capacity and degradability, the watering need is substantially reduced; a property highly desirable for applications such as remotely located mine site tailings and forests, where access to the site and water is limited. Furthermore, having the option of having nutrient additives and being degradable, the soil conditioners of the present invention provide a low-cost and sustainable alternative to existing soil conditioners.

In one embodiment, granular soil conditioners produced from feedstock materials of the present invention may be placed in a holding garden container of any make or size having an inlet connected to a rainwater downpipe of a dwelling or any building and an outlet with a valve to allow rainwater rich in nutrients from leaching of the granular soil conditioners to be directed to garden soils and plants.

Media for Odour Control in Food Production, Consumption and Food Waste Management

Agri-food, poultry, piggery, cheese manufacturing and meat slaughtering and related services, such as manufacture of compost collectively referred herein as food production and consumption industry, is one of the largest and fastest growing industries globally. Among the environmental factors associated with food production and consumption, food waste and odour have attracted great attention due to their substantial impact on environmental health and quality of life. Malodours from food waste composting plants present another problem and a reflection of direct relationship between food production/consumption and management of food waste, particularly in densely populated centres, where malodour from food production and composting plants has become the most demanding challenge for emerging environmental policy in many jurisdictions.

One major cause of odour generation is moisture retained in food waste, poultry and piggery bedding materials giving way to consequential increase in odour and ammonia (NH₃) emissions and microbial activity, particularly where food waste or bedding materials is stored for long time in anaerobic conditions. The broiler production is particularly most impacted industry, where the odour control and cost efficiencies of any proposed solution would be two key factors considered before uptake by poultry farm operators.

Major sources of odorous gases are Volatile organic compounds (VOCs), Ammonia, and volatile sulfur compounds (VSCs), with ammonia containing gases being the main component in food production and consumption industry. Major odour-causing compounds during composting are carbon-, nitrogen-, and sulphur-based, and include hydrogen sulphide, volatile organic sulphides, ammonia, pyridine, amines, hydrocarbons, terpenes, alcohols, ketones, aldehydes and esters. The relative abundance of these compounds is dependent on several factors including the feeder materials, composting process, and operating conditions, as well as the composting stage and operating conditions. Accordingly, odour control strategies for reducing environmental impact and improving quality of working environments will depend on nature and extent of odour control during food production, consumption, and waste management stages (one being composting).

Conventional odour control solutions include one or more processes of aeration, thermal or chemical oxidization, dehydration, (bio) filtration, scrubbing, activated carbon adsorption, addition of deodorants and mineral/synthetic solids such as zeolites, magnesium hydroxide and ferric chloride, or a combination thereof. These solutions are costly and each solution is designed for a specific odour problem to achieve a desired outcome, and therefore are application specific.

Consequentially, finding sustainable solutions to address odour challenge in a large industry encompassing food production, consumption and food waste management for effective reduction of environmental impacts and high life cycle cost of such solutions, is more than ever evident and particularly urgent due to sheer volume of wasted food being currently disposed in landfills or incinerated in many parts of the world.

It would be therefore advantageous to have an odour control solution that is not application specific and thus can addresses the needs across a number of industries along the supply chain. It would be desirable if such odour control solution can also address another waste challenge such as waste cardboard, the bulk of which currently ends up in landfills or incinerated. It would be highly desirable if the waste that is treated with said odour control solution can be used to produce value added downstream products such as compost amendments, thereby becoming a zero waste solution to the benefit of food producers, consumers and the environment. A solution of this nature which addresses product stewardship in both cardboard manufacturing and food production would be compatible with principles of circular economy.

In some embodiments, a method for producing a dry aggregate product for use as an effective, low cost odour control media across the whole supply chain of food production, consumption and food waste industry by following the steps (a) to (d) described above, wherein the treated waste can be optionally used as a feedstock for production of compost amendments.

The feedstock material can be applied universally to waste from full industry spectrum, starting from food production (such as cuttings of agri-food and off cuts from slaughtering), consumption (cuttings and food leftovers transferred to garbage bins of households, restaurants, hospitals, cruise and cargo shipping, military bases, aviation etc) to food waste management (waste collection, landfilling/incineration, processing for producing compost).

In one embodiment, the feedstock material produced according to the teachings of this invention, may be applied for effective odour control in food production and consumption, either in single or multiple rounds depending on source and intensity of malodour and the extent of control needed in each case. In general, the media of the present invention can be applied evenly to cover the exposed surface of food waste to a predetermined depth; the depth of media used will depend on the thickness, density and moisture content of waste materials, intensity of odour, and the level of masking effect needed to cause effective moisture and microbial activity reduction and odour capture during the storage of waste. The application of media can be repeated multiple times when fresh waste is added intermittently to the previously treated waste.

In another embodiment the feedstock material produced according to the teachings of this invention, may be applied for effective odour control in food waste management industries including food waste transport, landfilling, incineration and composting operations wherein the media of the present invention is mixed either continuously or intermittently with the waste being transported for landfilling/incineration or subjected to composting work environment odour control during preparation, processing and packaging operation.

The odour control media of the present invention is highly effective to reduce the intensity of odour generated by food waste. As an indication, depending on the type and age of the food waste, by applying a layer of media of the present invention on top of the food waste, odour intensity can be reduced by up to 90%, expressed in relative terms, reducing from “very strong” to “very weak” intensity. Optionally, the media can be mixed with the food waste to provide a similar or improved odour reduction. As reduction of odour is facilitated partially by absorption of fermented liquid onto the cardboard, the effective use of media may be further exemplified by its application to both the bottom and top of the food waste to provide long lasting effects. This application method is particularly effective in the case of food waste requiring long-term storage, such as in long-haul shipping and sea-going cruise operations, wherein large amounts of food waste is generated but cannot be disposed until reaching a port.

Odour control media of the present invention is an end-of-pipeline measure that can be formulated and manufactured according to site and product specific needs food industry to provide multiple benefits that in plurality lead to improved operational and cost efficiencies, compliance with environmental and circular economy guidelines currently unavailable with existing odour control solutions and practices. These efficacies and hence the benefits may include one or more of the following:
highly efficient reduction of malodour in agri-food production operations and distribution (e.g., cutting, packaging);
highly efficient reduction of food organic and garden organic malodour in households and larger food consuming industries such as restaurants, cafes, grocery retailers, hotels, schools, hospitals, military bases, aviation, cruise ships, cargo shipping, etc.;
highly efficient reduction of ammonia based malodourous gas generated typically in poultry and piggery operations;
highly efficient reduction for both ammonia and VOC (volatile organic compounds) malodourous gas generated typically in food waste composting plants either during active composting phase or curing phase;
environmental and work environment quality improvements in food production, consumption and food waste management industries gained through the above efficiencies;
the gain of the above mentioned efficiencies through the use of waste paper/cardboard in the odour control media of the present invention as cheap and plentiful moisture absorbent of fermented liquid from food waste which in turn diverts both food waste and cardboard waste away from landfills and incineration plants through downstream composting processes.

Composting Amendments from Food Waste

On a global scale, agri-food represents the largest source of food waste, and because of its low value the bulk ends up in landfills, as compared with other food waste sources that are largely composted for value adding and effective waste management. Consequentially, new solutions are needed for management of agri-food waste independent of current composting practices which deal largely with mixed food waste. These new waste management solutions need to be simple and cost effective to enable uptake by regional industry as environmentally sustainable options for local application. It would be advantageous if such solutions use other locally available waste resources such as waste paper/cardboard to achieve multiple environmental and cost efficiencies.

It would be also advantageous if the composting amendment solution reduces odour significantly by encapsulating the shredded food waste.

In one embodiment, a method for producing a granular feedstock material for use as an effective, low cost compost amendment by following steps described in prior embodiments to produce wet granules, which are either air dried or dried in an appropriate drying vessel, wherein one of the additives is shredded agri-food waste. The agri-food waste can be sourced from cuttings of fruit and vegetable during production and packaging, and food organics and garden organics from households and larger food consuming industries (i.e., restaurants, cafes, grocery retailers, hotels, schools, hospitals, military bases, aviation, cruise ships, cargo shipping, etc.).

In another embodiment, the agri-food particles can be shredded to equal size and include a predetermined amount of MAP or DAP as a supplementary additive to provide full nutritious effect to soil as a product value adding measure.

The compost amendment of the present invention provides an end-of-pipeline solution for effective diversion of substantial quantities of organic waste from landfilling as a stand-alone operation that can be implemented locally, where regardless of their low value and bulkiness, waste cardboard and agri-food waste require safe disposal.

Fillers for Goods Packaging and Padded Envelopes

The goods packaging materials manufacturing industry is a major user of cardboard facing a double-edged problem of using corrugated cardboard for both making boxes as well as for goods internal packaging, made from cardboard, plywood, timber, metal and other materials.

Corrugated cardboard for goods packaging represents around 30% of the total cardboard waste, with the latter ranging between 12% and 15% of total municipal solid waste around the world. This industry is under scrutiny particularly for substantial increase in the recent years in the usage of corrugated cardboard in packaging goods, primarily because of (a) the general move away from plastics/polymers as the materials of choice for packaging, and (b) substantial advances in use of multi-layer corrugated cardboard in new high-strength packaging structures that nowadays enable their extended use in packaging of substantially heavy industrial goods, providing substantial long-distance transportation advantages. Restrictions on population movements to due to the recent pandemic and consequentially increased e-food ordering has also caused increase in waste cardboard generation. A key disadvantage with the current use of corrugated cardboard as packaging materials, relates to inability for reuse following the completion of transportation of articles/products to their final destinations, as well as having a short recycling loop. These disadvantages have complicated the implementation of reverse logistics (product stewardship) which is being pursued by many jurisdictions to reduce the flow of waste cardboard to landfills and incineration.

Another packaging product of common usage padded envelopes which use recycled fibers such as shredded natural and macerated newsprint which are sandwiched between paper of the front and backsides of envelopes as protective padding. In the macerated newspaper varieties, a layer of thin, lightweight plastic with raised pockets of trapped air are commonly used to provide additional protective measures. Despite the ease and hence the attractiveness of such a packaging product the same disadvantages applicable to use of corrugated cardboard as packaging materials, explain above, applies herein. Additionally, the production of macerated newsprint involves wet pulping and addition of chemical softeners, which process generates liquid waste of significant quantities and concern to the manufacturers. Furthermore, inherited limitations with the strength and impact resistance, padded envelopes can only made up to certain sizes are considered suitable for transport of documents and similarly flexible objects. Also, the padded envelopes with plastic bubble wrap cushioning cannot be recycled easily because of the difficulty in separating the two materials.

Consequentially, finding sustainable solutions for packaging materials to reduce disposal of waste cardboard and environmental impacts, as well as the high life cycle cost of current disposal practices, is more than ever imperative and particularly urgent for the goods packaging materials manufacturing industry as well businesses using such materials, which are increasingly faced with product stewardship challenges.

It would be therefore advantageous for addressing the total supply chain issues faced by the industry and communities to convert waste packaging cardboard to usable industrial products and consumer goods to avoid landfilling and incineration needs. It would be highly desirable that the cardboard and plastic based cushioning used in the packaging industry be replaced with plastic-free, degradable and nutritious alternatives which can be placed in soil after their useful life.

In some embodiments, a method for producing feedstock materials with compaction range between 7% and 27% reduction in original thickness may be achieved by following steps described above, wherein the feedstock materials can be used as a loose filler or bagged filler occupying the open space around an article being packaged and conform with the shape and dimensions of said article or articles. The feedstock materials may also be used as a filler for padded envelopes being used for postage of one or more articles. Being a moisture, heat and odour absorbent, the material of the present invention may be directly applied or optionally first filled in purpose-built degradable and sealable containers/bags of any composition and configuration before placement around an article to conform with the shape and dimensions of said article or articles.

In some embodiments, a method for producing granular products with compressive strengths up to 1.36 MPa, from wet aggregates may be achieved by following the steps (e) and (f) described above, wherein the said granules are dimensionally stable and meet end use requirements, i.e. elasticity and impact strength, can be used as a loose or a packed filler for goods packaging as per teachings of the previous embodiment. As indicated earlier, the method of present invention provides a means of one or more recycling/screening steps for producing best-fit granule size for specific packaging filling applications. In the foregoing embodiments where the granules are not intended for moisture control (i.e. when granules are placed in bags), the granules can be optionally coated with a biodegradable organic resin, such as shellac or a gum resin, to improve compressive and tensile strength of the said packaging fillers.

The product and goods packaging fillers of the present invention provide several environment and cost advantages unmatched by existing fillers, including but not limited to:
substantial inclusion of pulp/chippings sourced from waste paper/cardboard;
versatility for application as either a loose aggregate or granular filler for packaging and safe transport of industrial products and consumer goods satisfying diverse needs such as moisture, heat and odour control and elasticity for absorbing shock during transport;
reusability or disposal of used packaging fillers in soil to become degraded and provide soil conditioning effects;
an effective replacement for silica based moisture absorbents commonly used in consumer good packaging;
suitable low-cost filler for cushioning products and goods during transport ranging from light to medium weight

Decorative Garden Pebbles

Pebbles used for decorating gardens are currently sourced from limited and non-replenishable river beds and coastal dredging operations which have significant environmental impact on riverine and coastal ecologies and sustainable resource management. Such garden pebbles come from countries relaxed mining and environmental regulations, are expensive and limited in colour and size. Accordingly, it would be advantageous to address the market demand for decorative pebbles whilst addressing adverse impacts of sourcing such pebbles from natural but un-replenishable resources. It would be desirable for an alternative pebble product to provide additional benefits such as nutritious and conditioning effects on soil with which they are in contact with. It would be even more desirable for an alternative pebble product containing waste cardboard which degrade in the receiving soils over time and thus reduce the need for landfilling or incinerating waste cardboard.

In some embodiments, a method for producing decorative garden pebble products, containing dry pulp/chippings from defibring waste paper and cardboard by following steps (a) and (d) described above, wherein the said granules are dimensionally stable and meet the gardener's requirements, including but limited to aesthetic features (ie colour and their combinations), size and durability. The decorative garden pebbles produced according to the teachings of this invention offer added advantages unmatched by pebbles from natural sources or synthetic alternatives, namely degradability and nutritious effects on soils through time. The other unique advantages of the pebble production process disclosed herein pebbles include the ability to the control the size of pebbles during manufacturing as disclosed earlier or alternatively using fragments of recycled plasterboard as a nucleus for making pebbles of desired shapes and sizes as disclosed in earlier embodiments. Pebbles may include a pre-determined amount of a herbicide as an additive to the production process described above. Additionally, the pebbles can be optionally coated with a biodegradable organic resin, such as shellac or a gum resin, to repel moisture as a means for longevity of the product.

Grow Media for Urban and Indoor Farming

One of the most important decisions in urban and indoor farming, relates to selection of an appropriate grow media to enable cost effective crop production in an environmentally sustainable manner. There are many different ingredients in the markets that can be used to make a growing medium from organic (such as peat, bark) or inorganic (such as rockwool, perlite) sources. Growing media are often formulated from a blend of such raw materials for providing stable growth environment particularly a correct balance of air and water holding capacity and bulk density of the media.

However, as food production cost in urban and indoor farming operations is directly affected by the costs of raw materials and transport of such materials to production site constraints with the availability and sustainability of sourcing certain materials, exemplified by peat and rockwool may adversely affect the correct air and water balances required for productive urban and indoor farming. Accordingly, it would be advantageous for farmers having access to grow media that are produced from sustainably sourced ingredients that enable formulation of cost effective grow media, with properties comparable or even better that the grow media produced from conventional ingredients. It would be desirable for alternative grow media produced from replenishable resources that provide additional benefits such as nutritious and conditioning effects on soil additives with which they are mixed with to provide balanced air/water holding capacity and density. It would be even more desirable for an alternative product with collateral benefit, such as a degradable grow media that incorporates waste paper/cardboard, that reduce the need for landfilling or incineration.

In one embodiment, a method for producing a degradable ingredient media, containing dry pulp/chippings from defibring of waste paper and cardboard, by following steps (a) and (c) and description provided, wherein the generated wet aggregate is dried in air or in an appropriate drying vessel to provide a stable ingredient for mixing with soil to produce a nutritious grow media. Apart from providing correct balance of air and water holding capacity and bulk density, the media ingredient produced according to the teachings of this invention offers added inherent advantages unmatched by commercially available alternatives, namely soil conditioning effects, pH adjustment and degradability through time, as well as compatibility for mixing with other grow media ingredients, like perlite and vermiculite, for product value adding.

Summary of the Products' Advantages

As described above, the present invention provides a degradable feedstock materials and methods for production of diverse industrial products and consumer goods from such feedstock materials, which products and goods offer a number of advantages over the existing ones, some of which are summarised below:
the use of waste paper/cardboard, as a substantial portion of the feedstock materials and products thereof, reduces burden on receiving landfills and/or incineration processes;
the availability of precursor minerals from widely occurring mineral deposits or from infinite seawater resources enables cost-effective and sustainable production of feedstock materials; this in turn enables the implementation of sustainable product manufacturing operations in multiple locations at any scale according to local and regional market demands;
high workability and degradability make the feedstock materials amenable to optimised engineering design for economic mass manufacture of diverse industrial products and consumer goods, having superior functionality and added environmental benefits, compared to products already available;
flexibility and scalability of feedstock materials production technology allows manufacturing operations at both local and regional scale, and a means to redress the environmental and cost burdens associated with storage;
the feedstock materials, systems, assemblies, and methods of the present invention provide industrial products and consumer goods with functionalities, such as low density and water retention capacity, nutritious effects, collectively unsurpassed by market available products and goods;
substantial reduction in malodour generated by food production, food consumption and food waste industries, achieved by using a media of present invention; and
degradability of the products and goods produced (using feedstock materials and methods of the present invention) when placed in soil, reduces or eliminates the need for landfilling and/or incineration—a key feature of the products of the present invention.

In summary, this invention represents some of the many ways in which the production of degradable products and goods, comprising a significant proportion of waste paper/cardboard, may be realised according to methods and systems disclosed in the foregoing embodiments. However, the invention is not restricted to the described embodiments, as it will be understood that many variants are possible, including combinations of the features described in one of more of the above disclosed embodiments. Such variants will be apparent for the person skilled in the art and are considered to fall within the scope of the invention. Furthermore, those skilled in the art will readily appreciate that all parameters, dimensions and/or configurations described herein are meant to be exemplary and that the actual parameters, dimensions and/or configurations will depend upon the specific application or applications for which the inventive teachings is/are used.

### EXAMPLES

### Example 1—Mineralogical Composition and Setting Time of Feedstock Materials

For determining the mineralogical composition of the feedstock materials used for manufacture of products and goods three tablets (for mineralogical identification) and respective stubs (for measuring setting time) were prepared from a finely ground dry mineral mixture comprised of 88% w/w bassanite, 10% w/w magnesia and 2% w/w arcanite. This composition was used in most trials for production of feedstock and products referred to in this and following examples. In this example, the dry mineral mixture was mixed thoroughly with 10% w/w pulp (by weight of total solid weight) for about 2 minutes to which 90% w/w freshwater (by weight of total solid weight) was added and thoroughly mixed for an additional 2 minutes to produce a consistently uniform feedstock materials. The produced feedstock materials were then transferred into cups and stubs of the same size and tapped onto a flat surface to flatten and shape into tablets, to produce three tablets (1 cm in thickness and 5 cm in diameter) and three stubs (35 mm×35 mm×35 mm), which were left to set in room temperature while measuring the pH of the feedstock materials. The setting time of the stubs were determined using a Vicat needle apparatus (Labgo Vicat) with a needle 1.13 mm in diameter following guidelines recommended by the equipment supplier. As indicated in Table 1, the setting time of the feedstock materials is within 20 minutes with pH of the mineral aggregate varying between 13-13.5.

Mineralogical composition of each tablet, after hardening in room temperature for 21 days, was determined qualitatively by X-Ray Diffraction (XRD) method using powders produced by pulverising about half of each tablet. A Bruker D8 DISCOVER XRD unit, operated at a voltage of 40 kV and a current of 40 mA, and a Diffractometer EVA V4.2 software were used for mineralogical determination.

TABLE 2
Mineralogical composition and setting time of feedstock materials

| Number of Replicate samples | 1 | 2 | 3 |
|---|---|---|---|
| pH of mineral aggregate prior to | 13 | 13.5 | 13 |
| setting | | | |
| Setting time (min) | 20 | 20 | 20 |

Mineral abundance in the hardened feedstock materials:

| | | | |
|---|---|---|---|
| Major (>30%) | Gypsum | Gypsum | Gypsum |
| Moderate (10-30%) | Syngenite | Syngenite | Syngenite |
| Minor (<10%) | Kieserite, | Brucite | Kieserite, |
| | Brucite | | Brucite |

As shown in Table 2, gypsum and syngenite represent the major and moderate mineral components respectively of the feedstock materials prepared. Brucite and kieserite form minor components of the feedstock materials. As discussed in the embodiments of this invention, because of qualitative nature of XRD analysis, the type and percentage of magnesium sulphate and Ca/Mg minerals recorded by XRD analysis depends on the state of hydration status of the composite which is indirectly a reflection of the room temperature and humidity during the drying phase of the composite.

### Example 2—Physical Characteristics (Bulk Density, Compression and Compaction) of Feedstock Materials

For determining physical characteristics of the feedstock materials, large number of test materials were made from mineral mixture (as described in Example 1), fresh water and pulp added in various proportions and dried in room temperature over 116 days starting from the date of setting to prepare cubic test specimens (44 mm×44 mm×40 mm) for compressive test according the ASTM C109 guidelines. Compressive strength, expressed in MPa, of the specimens was determined using SHIMADZU AG-X 50 kN test machine at a loading rate of 1 mm/min.

For determining compaction percentage of feedstock materials, several test samples were produced according to method described in Example 1. The samples were dried in room temperature over 21 days, starting from the date of setting. The compaction rate, expressed as the percentage of compacted height of a sample by the original height of the sample, involved filling a cylindrical container (55 mm diameter, 15 mm height) with an evenly distributed sample from the base to top of the container and placing the container at the centre of the testing space of the Digital Spring Tester ATH-200. Then by gently driving the handgrip downwardly, the upper platen was brought into contact with the top surface of the sample during the consolidation process. Once the maximum load (200N) was applied, the compaction percentage was calculated by pulling-out the spring load and measuring the compacted height of the sample inside the container. The results of the compaction test were compared with products available in market in the form of padded envelope and polystyrene peanuts.

Bulk densities of all test samples were determined using standard procedure and expressed in g/cm³. Table 3 lists the results of test works performed for physical characterisation of feedstock materials and provides examples of their application areas.

TABLE 3
Physical characteristics of feedstock materials

| | | | | Compaction | | |
|---|---|---|---|---|---|---|
| | Pulp | | | percentage | | |
| | content | | | (% of | | |
| | of dry | | | reduction in | | |
| | feedstock | | Compressive | original | Bulk | |
| Feedstock | materials | No. of | strength | sample | density | Examples of |
| forms | %(w/w) | samples | (MPa) | height) | (g/cc) | application areas |
| Aggregate | 30-60 | 53 | 0.11-0.22 | 7-27 | 0.29-1.05 | Malodour control |
| | | | | | | media, packaging |
| | | | | | | fillers |
| Aggregate | 20-30 | 91 | 0.45-1.36 | NA | 0.02-1.22 | Packaging fillers, |
| Granules, | | | | | | plantable |
| Sheets | | | | | | containers, sheet |
| | | | | | | mulch, soil |
| | | | | | | conditioners, |
| | | | | | | decorative |
| | | | | | | pebbles, compost |
| | | | | | | amendments, |
| | | | | | | grow media |
| Aggregate, | 10-20 | 35 | 1.33-3.12 | NA | 0.68-1.70 | Decorative |
| Granules | | | | | | pebbles, |
| | | | | | | packaging sheets |

As expected and shown in Table 3, overall, the compressive strength invariably shows inverse relationship to pulp content in the feedstock materials ranging between 0.11-3.12 MPa.

As the shape, size and physical strength of granules made from feedstock materials described in Example 1 is of interest for optimizing their performance for various application areas, failure load was measured for a large number of granules ranging in diameter between 5 mm and 80 mm. The maximum load carried by the granules ranged between 0.02 kN and 1.3 kN, which indicates suitability of the granules for application ranging from compost amendments to soil conditioner, packaging fillers and decorative granules and pebbles.

As indicated in Table 3, the compaction percentage of aggregates comprised of raw pulp, binder and/or additive is significantly lower than the available polystyrenes, raw pulp and padded envelope pulp. With respect to carboard pulp, the compaction percentage of the coated pulp is significantly lower than that of the raw pulp. The compaction percentage of uncoated aggregates ranged between 7-27%, with the coated aggregates having compaction percentage of only 3%, which is significantly lower than that of the uncoated aggregates.

Compaction rates of feedstock materials in aggregate form range between 7%-27%, showing significantly lower value than the commercially available packaging fillers (including polystyrene peanuts and macerated newsprint in padded envelope), which were measured concurrently and ranges between 33%-88%.

The bulk density of feedstock materials, as indicated in Table 3, ranges between 0.02 g/cc and 1.70 g/cc. Generally, the median value of bulk density of all samples tested shows an inverse relationship to the pulp content in feedstock materials.

### Example 3—WAC and WRC of Products from Feedstock Materials

As the water retention capacity (WRC) of products is critically important for products manufactured from feedstock materials produced, according to method described in Example 1, large number of dried products (including plantable containers, soil conditionals, grow media, nutritious granules and compost amendments) after hardening in room temperature for 21 days, were subjected testing for water absorption capacity (WAC) and water retention capacity (WRC).

WAC is defined as the percentage of water absorbed by the walls and the base of a product, and measured as weight percentage of water absorbed by the walls and base of a product to that of the total dry weight of the product. This involved immersing a product in water for about 30 minutes then removing the excess water from the product before immediately determining the wet weight of the product and calculating the weight percentage difference between the wet and dry weights of the product.

WRC is a measure of duration (expressed in days) that a product holds water before reaching its dry weight. It was determined by monitoring the change in the amount of water absorbed over time by the walls and base of a product held in room temperature (20±5° C.), until the weight of the product has almost reached its original dry weight, due to evaporative water loss. WRC values were considered reasonable for a container having 10% w/w water (representing free water) in excess of the weight of the container dried in oven at 60° C. for 2 days.

TABLE 4
Water absorption and water retention capacities of the products from feedstock materials

| | Pulp content of | | Water absorption | | |
|---|---|---|---|---|---|
| | dry feedstock | | capacity | Water retention | |
| Examples of | materials | No. of | (%(w/w) of total | capacity | Feedstock |
| application areas | %(w/w) | samples | dry weight) | (days) | forms |
| Media for malodour | 30-60 | 71 | 40-149 | 7-32 | Aggregate |
| control, packaging fillers | | | | | |
| Packaging fillers, | 20-30 | 51 | 27-200 | 22-28 | Aggregate, |
| plantable containers, | | | | | Granules, |
| sheet mulch, soil | | | | | Sheets |
| conditioners, decorative | | | | | |
| pebbles, compost | | | | | |
| amendments, grow media | | | | | |
| Decorative pebbles, | 10-20 | 46 | 19-83 | 17-22 | Aggregate, |
| packaging sheets | | | | | Granules |

As indicated in Table 4, out of 168 samples tested, the average value of the WRC of feedstock materials varies between 19 days to 25 days, with the lowest value being 7 days and the highest value being 32 days. Such high values of WRC, while being a reflection of high values of WAC of the feedstock materials (in range from 19% (w/w) and 200% (w/w), are directly controlled by the pulp content of dry feedstock materials.

Visual observations confirmed that all test samples remained reasonably hard and maintained their original shape and integrity during the absorption/retention trials. Further it was observed that neither the geometric shape nor the volume of the containers had a significant influence on the WAC values; the only exception related to wall thickness of the containers that exerted influence on the WAC values. Accordingly, where the plantable containers had about or above 5 mm wall thickness, the WRC values were on average 20% higher in retention days compared to that of containers with wall thicknesses less than 5 mm (such as grow cubes and hydroponic pots).

### Example 4—Media for Food Waste Odour Control

To evaluate the efficiency of feedstock materials of the present invention as odour control media, feedstock materials produced according to method described in Example 1 were used for determining reduction of odour intensity of agri-food waste. The waste was collected from kitchen bins of households and comprised of fruit cuttings, vegetable skins, flower cuttings and garden cuttings. The collected food waste samples were immediately mixed and stored from one day to three weeks long before odour intensity tests were undertaken. As the food waste samples were transferred from their sources to laboratory for sorting and splitting before assessment, determination were made by a panel comprised of five persons (participating in all determinations), in preference to use of conventional dynamic olfactometry method. The odour intensity, defined as a perceived strength of an odour above its threshold, was determined by the odour panel. Due to the qualitative nature of the results, no attempt was made to establish the relationship between odour intensity and odour concentration.

For odour intensity determinations, the media was applied in three ways to food wastes that were stored in plastic containers of the same size and volume and kept for set periods in cool conditions (2-10° C.) prior to determination. Media was applied on top, or top and bottom or mixed with the food waste, with food waste to media ratio ranging between 1.4-4 by weight for all three application methods. Overall, odour intensity determinations were performed for 5 rounds, each comprised of three media application methods, and storage durations of 1 day, 1 week and 3 weeks. In each round of determination, panel members were first presented with odourless reference sample and asked to rate the odour strength of test samples, before and after media application using the scale categories of “not perceptible”, “very weak”, “weak”, “distinct”, “strong”, “very strong” and “extremely strong”. The collective determinations pointed to efficiency of the media used for odour intensity reduction ranging between 70% and 90% for all food waste test samples stored from 1 day to 3 weeks with the highest efficiency obtained from samples with shortest storage duration.

Based on results obtained, it was found that the most effective results in terms of odour reduction, and hence reflecting the most efficient method of application relates to food waste covered with a layer of media at the top and bottom, wherein the bottom layer of media absorbs the bottom liquid generated by food waste storage, thus significantly reducing fermentation and hence odour generation processes. Results of media application trials on food waste composed of meat, chicken and fish cuttings, although pointing to significant odour reduction, were considered non conclusive because of limitations with sample quantities and numbers.

### Example 5—Nutrient Release from Water Leaching of Products

In order to assess the extent of nutrient release from granules produced according to the method described in Example 1, an assemblage of granules with diverse sizes, shapes and compositions were subjected to a first round of immersion in freshwater (tap water) with leachate samples collected after 1 hour, 1 day, 7 days and 14 days of water immersion and the main nutrient constituents analysed immediately after each sampling event. The leaching trial was repeated on the oven-dried granules (at 80° C.) from the first round of leaching. The size of the granules ranged between 10 mm and 30 mm and water to granules ratio was maintained at 2:1 by weight for all trials. For quality control, chemical analysis of selected replicate leachates samples were also performed at an independent laboratory.

TABLE 5
Nutrient leaching from products formed form feedstock materials

| Round of | Duration of | | | | | | |
|---|---|---|---|---|---|---|---|
| leaching | leaching | | NH₃—N | NO₃—N | NO₂—N | PO₄ | K |
| trial | trial | | (mg/L) | (mg/L) | (mg/L) | (mg/L) | (mg/L) |
| 1 | 1 | hr | 1.75 | 18.3 | 0 | 7.7 | 190 |
| 1 | 1 | Day | 110.4 | 76 | 0.17 | 21 | 740 |
| 1 | 7 | Days | 465.52 | 205 | 1.07 | 32 | 1700 |
| 1 | 14 | Days | 524.4 | 153 | 1.19 | 24 | 1200 |
| 2 | 1 | hr | 16.744 | 0 | 0.03 | 25.6 | 82 |
| 2 | 1 | Day | 45.08 | 75 | 0.17 | 22 | 260 |
| 2 | 7 | Days | 126.04 | 223 | 0.49 | 41 | 400 |
| 2 | 14 | Days | 239.2 | 218 | 0.55 | 37 | 440 |

Table 5 tabulates the nutrient analysis results of leachates obtained from water immersion of granules coated with gum according to above described process. The coated granules were made from 55% w/w bassanite, 6% w/w magnesia, 2% w/w arcanite, 37% pulp (all expressed as weight percentage of dry mixture) to which fresh water (about 90% by weight of total solid weight) was added to induce chemical leaching. As expected and as shown in this table, the concentration of the main nutrients (nitrogen, phosphorus, and potassium) in the leachates progressively increased with time. Visual observations indicated that both the immersed and subsequently oven-dried granules retained their form and structural integrity regardless of the length of immersion, a feature which is considered highly favourable for the use of gum-coated granules for heavy-duty goods packaging and decorative pebbles and granules applications, as well as for use in containerised soil conditioners that can be optionally connected to rain water down pipes of a dwelling or any other appropriate freshwater source for controlled supply of liquid nutrient to garden soils.

### Example 6—Degradation of Products

Degradation of products, such as plantable containers and granules, when buried in soil is a function of physical, chemical, and biological processes acting simultaneously in the soil profile, subjected to intermittent wetting and drying events. To evaluate the degradation potential of feedstock materials of the present invention, a two-part trial was undertaken as described below.

Part 1 of the Trial

The first part of the trial involved assessment of hardness, as an indication of degradability potential of the feedstock materials, by performing a needle penetration test on a variety of products immersed in water over a long period of time. The products included plantable containers, granules, pebbles, grow cubes and mulch sheets and visual observations were made during needle testing to evaluate the influence of water on the physical integrity of the products assuming that the products once buried in soil, become exposed to vagaries of aqueous chemical reactions (solid-liquid reactions) active in the soil vadose zone. The procedure used involved penetrating a stainless-steel needle through the walls of the products immersed in water for set periods of time, a method considered by the inventors to be a non-destructive index test for continued assessment of hardness of the products beyond the measurements reported in this example.

Overall, a total of 66 product samples of various compositions (listed in Table 6), sizes, shapes and dimensions were tested in this part of the trial. The samples were placed in plastic holding containers, and fully immersed in pre-determined amounts of freshwater. When required, water was added to ensure that the samples were fully immersed and standing water was gently agitated by a spoon at the time of measuring the pH values. The first comprehensive observation round was undertaken 6 months after the date of immersing the last sample and, in addition to a needle penetration test it included close visual observation by 3 people of the physical features of the immersed samples, including their structural integrity, scratch-ability and sample decolouration effects. Hardness of the product samples was assessed by needle penetration test method, with the extent of penetration of a 2 mm diameter of a needle, with blunt end, through the walls of the immersed samples taken as a measure of hardness. For developing a comparative base, two cork tablets, each 10 mm in thickness but of different compactions, were also tested. In the case of the higher compact cork tablet that resisted to needle penetration, a hardness scale of “5” was assigned, which is closely equivalent to mineral talc hardness in Mohs Scale of mineral hardness (a commonly used scale in earth sciences for characterising the scratch resistance of various minerals). For the lower compact cork tablet, with 5 mm needle penetration, a hardness scale of “0” was assigned.

TABLE 6
Long-term observation results for feedstock materials

| | | | Number of days | | | |
|---|---|---|---|---|---|---|
| | | | samples immersed | Water pH | | |
| Additives | wt % | | in water to the | range on the | Physical status of | |
| included in | (range), | Number | date of needle | date of needle | samples on the | Hardness |
| the mineral | Dry | of | penetration | penetration | date of needle | range of |
| mixture | basis | samples | test | test | penetration test | samples |
| None | — | 12 | 196-294 | 6.5-8.5 | 8 intact, 3 fully and | 2-4 |
| | | | | | 1 partially collapsed | |
| Sand | 3-7 | 8 | 245-294 | 6-9.5 | 2 intact and 6 fully | 2-5 |
| | | | | | collapsed | |
| MAP | 2-8 | 2 | 294 | 8.5-9.5 | All intact | 1-4 |
| Color | 0.5-2 | 17 | 108-273 | 7-9 | 12 intact, 3 fully and | 2-4 |
| | | | | | 2 partially collapsed | |
| Coating agent | 0.5-2 | 7 | 196-268 | 7.5-8.5 | All intact | 2-5 |
| Color + Coated | 1-4 | 7 | 107 | 8-8.5 | All intact | 2-5 |
| granules | | | | | | |
| Sand + MAP + | 3-15 | 6 | 196-294 | 8.5-9 | 4 intact and 2 | 2-4 |
| Color | | | | | partially collapsed | |
| Sand + Color | 3-9 | 7 | 245-273 | 7.5-8.5 | All intact | 2-5 |

Table 6 provides the results of the visual observations, needle test, as well as the water pH measurements, carried out on all samples 7 months after the first day of water immersion of the last sample. As shown in this table, needle penetrations of less than 5 mm were obtained for all product samples. Visual observations throughout the prior 7 months indicated that the majority of the product samples remained largely intact over a minimum of 3.5 months continuous immersion in water, as defined by the integrity of the products' original structure. The needle tests of the same samples, following 7 months of continuous water immersion, indicated however that most of the visually intact samples were mildly to moderately hard, as shown by their relative hardness value and also the ease of needle penetration through the walls of the samples with minimal pressure. There was no collapsed container products during the first 3.5 months of water immersion. Long term observations indicated that following these months some of the container products, marked with higher proportion of pulp content, became increasingly susceptibility to volume expansion, weakening of their structural matrix and eventual collapse.

The visual observations by team also confirmed the effective retention of the colour and colour intensity of the coloured samples, regardless of the type of the colourants, the presence or otherwise of other additives, and pH of water which remained mildly alkaline during the monitoring period.

Part 2 of the Trial

In the second part of the trial, to assess the degradation potential of products from feedstock materials produced according to method described in Example 1, visual observations were made specifically on the extent of degradation of planted containers placed in soil and watered as the other plants grown nearby in the same soil type and depth. The observations included microscopic examination, supplemented by determination of mineralogical composition of the residue left behind from planted containers visually degraded in soil, using the X-Ray Diffraction method described in Example 1.

For a broad-based assessment, a large number of containers, representing replicates of the container types made from feedstock materials, containing various additives listed in Table 6 were planted with seedlings of plant species commonly used for nursery production and forestry plantation, as well as the seeds of leafy greens. All planted containers were placed in soil for degradation observations. For a comparative assessment, five replicate sets of uncoloured nursery containers of the same size, shape and dimensions, were also included, one set being devoid of any additive (as reference containers) and the remaining replicate sets containing quartzose sand, sawdust, NPK pellets and sawdust-containing NPK pellets, respectively. All replicate container sets were planted with a single perennial species (Eucalyptus saligna, “Sydney Blue Gum”) and placed in rows in a custom-built raised garden bed with a Perspex frontal shield for ease of viewing. Visual observation of the containers after 6 months of plant growth, displayed partial or total dislodgement of the lower half of all containers from their main body due to combination of plant root growth through the walls as well as the cavities generated by dissolution of precursor N-P-K pellets. Close-up viewing of a duplicate of each set removed from the raised garden bed indicated significant mineralogical decomposition in and around the dislodged portions of the planted containers leaving behind whitish loose and friable particles, 5-10 mm across.

Following 12 months of plant growth to mature stage, the second duplicates of each plant set in the raised garden bed were removed from surrounding soils of the raised bed and carefully placed on a bench for further visual observations and microscopic examination. The visual observations clearly indicated root outgrowth beyond the boundaries of pre-existing containers. Microscopic observations, supported by XRD mineralogical determinations confirmed minor presence of whitish nodules, in the range of 0.2-5 mm across, dominated by mineral gypsum (over 98% (w/w)). Trace amounts of brucite and epsomite minerals (recorded in XRD scans) and tiny shreds of decaying pulp materials were also observed in the case of some samples. Similar gypsum dominated residue and decaying shreds of pulp have been also observed in the case of few containers planted with seedlings of nursery and forestry revegetation species; however, the roots of the majority of the plants were devoid of any residue, indicating full degradation of the containers through time.

Based on the outcomes of the above trial, the agricultural containers, made from feedstock materials of this invention, become degraded in soil within a 6-12 month period; however, as it would be appreciated by horticulturists, the degradation rate and hence its duration will depend on a number of parameters including but not limited to mineralogical composition, the extent of wetting-drying events in the soil profile, and soil disturbance by physical and biological activities, that are known to be operating simultaneously in the soil vadose zone.

It will be understood to persons skilled in the art of the invention that many modifications may be made without departing from the spirit and scope of the invention. All such modifications are intended to fall within the scope of the following claims.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A feedstock material comprising particles of a comminuted paper product having fibrous portions on an outer surface thereof distributed throughout a diagenetically formed mineral aggregate comprising gypsum, syngenite and magnesium hydroxide and/or magnesium sulphate, wherein the feedstock material is adapted to degrade when buried.

2. (canceled)

3. The feedstock material of claim 1, wherein the paper product is waste cardboard and/or waste paper.

4. The feedstock material of claim 1, wherein the comminuted paper product has a size of about 0.2-1 cm across.

5. The feedstock material of claim 1, comprising between about 10% and 60%. (w/w) of the paper product, between about 30% and 80% (w/w) gypsum, between about 0.5% and 30% (w/w) syngenite and between about 2% and 10% (w/w) of magnesium hydroxide and/or magnesium sulphate.

6. (canceled)

7. (canceled)

8. (canceled)

9. The feedstock material of claim 1, wherein the magnesium hydroxide and/or magnesium sulphate are selected from one or more of the group consisting of: brucite, kieserite, starkeyite and epsomite.

10. The feedstock material of claim 1, further comprising one or more additives selected from the group consisting of: inorganic fillers, organic fibers, pesticides, colourants, coating agents and fertilisers.

11. The feedstock material of claim 1, wherein the feedstock material is a granular feedstock material and the granules have a particle size of about 0.5-10 cm.

12. The feedstock material of claim 11, wherein the granulated feedstock material is provided in the form of a granule-containing sheet.

13. A product produced from the feedstock material of claim 1, wherein the product is selected from the group consisting of: a plantable container, a mulch for weed control, a soil conditioner, a fertiliser, a growth media, a media for control of malodour, a filler for goods packaging and padded envelopes, food waste containing compost amendment and decorative garden pebbles.

14. (canceled)

15. (canceled)

16. (canceled)

17. (canceled)

18. A method for producing a feedstock material that is adapted to degrade when buried, the method comprising:
comminuting a paper product whereby particles having a fibrous portions on an outer surface thereof are produced;
mixing the particles of comminuted paper product with a precursor mineral mixture that comprises finely ground bassanite, magnesia and arcanite; and
hydrating and stirring the mixture, whereby a self-binding mineral aggregate diagenetically forms, with the comminuted paper particles distributed throughout.

19. The method of claim 18, wherein the paper product is waste paper and/or cardboard.

20. The method of claim 18, wherein the paper product is comminuted by dry defibring or chipping.

21. The method of claim 18, wherein the paper product is comminuted such that particles having a size of about 0.2-1 cm across are produced.

22. (canceled)

23. (canceled)

24. The method of claim 18, further comprising adding a seeding agent during stirring of the mixture, whereby the setting time of the mineral aggregate is reduced, and/or a retarding agent effective to slow the setting of the mineral aggregate during stirring of the mixture.

25. (canceled)

26. The method of claim 18, further comprising blowing a gas into the mixture during stirring, whereby a porosity of the mineral aggregate is increased.

27. (canceled)

28. (canceled)

29. (canceled)

30. (canceled)

31. (canceled)

32. The method of claim 18, wherein one or more additives selected from the group consisting of: inorganic fillers, organic fibers, pesticides, colourants, coating agents and fertilisers are mixed with the particles of comminuted paper product and the precursor mineral mixture.

33. (canceled)

34. The method of claim 18, further comprising granulating the self-binding mineral aggregate with the comminuted paper particles distributed throughout, whereby a feedstock material in the form of a wet granule is produced.

35. The method of claim 34, wherein the wet granule is further processed to produce a sheet material comprising granules.

36. The method of claim 18, further comprising shaping the feedstock material into a shape that defines a product.

37. (canceled)

38. The method of claim 18, further comprising drying the feedstock material whereby a product is formed.

39. (canceled)

40. (canceled)

41. (canceled)

42. (canceled)

43. (canceled)
